(19) United States
(12) Patent Application Publication
(10) Pub. No.: US 2025/0272936 A1
(43) Pub. Date: Aug. 28, 2025

(54) COMPUTING DEVICE AND METHOD FOR PROVIDING INTERACTIVE THREE-DIMENSIONAL (3D) WORKSPACE ENVIRONMENT

(71) Applicant: Sondra Phifer, Sunnyside, NY (US)

(72) Inventor: Sondra Phifer, Sunnyside, NY (US)

(21) Appl. No.: 19/062,072

(22) Filed: Feb. 25, 2025

Related U.S. Application Data
(60) Provisional application No. 63/558,618, filed on Feb. 27, 2024.

(51) Int. Cl. G06T 19/20; G06V 20/70

(52) U.S. Cl. CPC G06T 19/20; G06V 20/70; G06T 2219/2004; G06T 2219/2012; G06T 2219/2016

(57) ABSTRACT

In an embodiment, a computing device for providing an interactive 3D workspace is disclosed. The computing device receives user input to select between a single-user or multi-user 3D workspace room, rendering appropriate workspace with depth effects. It prompts the user to import a 3D object file and displays it in the workspace. The computing device renders a user interface to interact with the 3D object. For a single-user workspace, the computing device displays an active user cursor with user details moving with the cursor. For a multi-user 3D workspace room, the computing device renders multiple user cursors, each with user details that move with the corresponding cursor. When annotating a 3D object, the computing device activates a tool that replaces the user details with an annotation indicator adjacent to the active user cursor.

### TECHNOLOGICAL FIELD

The present disclosure is directed to systems and methods for providing an interactive three-dimensional (3D) workspace environment. More specifically, the present disclosure is directed to systems and methods facilitating enhanced dynamic three-dimensional computerized object generation and presentation via interactive three-dimensional workspaces.

### BACKGROUND

In general, educators want their students to succeed. However, currently employed methods of teaching students and assessing their learning may inadvertently impede the cultivation of higher-order thinking skills. Bloom's Taxonomy, a framework for categorizing learning objectives, delineates cognitive processes in hierarchical order: remembering, understanding, applying, analyzing, evaluating, and creating. The misalignment between learning objectives, instructional strategies, and assessments can hinder students from successfully reaching their goals. Many courses tend to adopt learning objectives that inadequately foster higher-order thinking skills, said objectives being predominantly focused on the lower tiers of Bloom's Taxonomy (e.g., understanding and remembering).

Common instructional approaches often blend lectures with class discussion, which provides limited opportunities for students to utilize skills crucial for demonstrating competence. Such an instructional approach typically employs one-way communication or controlled discussions, limiting participation to a few students at a time. Furthermore, typical assessment formats are insufficient to effectively gauge student learning. For instance, after months of note taking during lectures, students are often required to showcase critical thinking through extensive single-topic research papers. This approach requires students to transition from passively absorbing information to actively employing higher-order critical thinking skills that may not have been cultivated throughout the semester.

Relying solely on lectures, controlled discussions, and research papers proves insufficient for nurturing critical thinking skills. Similarly, in large lecture halls, students are often evaluated through midterm and final exams that primarily require the recall and description of facts.

Unfortunately, such assessment formats fail to prompt students to make profound connections regarding the social, historical, and cultural nuances influencing the subject matter.

Accordingly, it would be desirable to provide educators with a tool capable of facilitating the development of higher-order critical thinking skills. It would further be desirable to provide educators with a tool enabling students to actively engage in the learning process to aid in the development of critical thinking skills in students.

Hence, the provided systems and methods, incorporating these advantageous features, present an innovative solution to facilitate enhanced dynamic three-dimensional computerized object generation and presentation.

### SUMMARY

According to one embodiment, a computing device for providing an interactive three-dimensional (3D) workspace environment is disclosed. The computing device may include a processor and a memory. The memory is coupled to the processor and stores computer-executable instructions which when executed by the processor cause the processor to receive a user input indicative of selection of one of a single-user 3D workspace room and a multi-user 3D workspace room. The processor may further render a 3D workspace, with a depth effect, based on the selected 3D workspace room, and provide a prompt for a user to import a 3D object file indicative of a 3D object, the 3D object being displayed in the 3D workspace, and 3D object file being imported from the memory or an external computing device. The processor may further render a user interface for the user to interact with the rendered 3D object in the 3D workspace. In response to receiving the user input indicative of the single-user 3D workspace room, the processor may render an active user cursor and details of the user, accessing the single-user 3D workspace room, adjacent to the active user cursor, such that the details of the user move together with the movement of the active user cursor. Further, in response to receiving the user input indicative of the multi-user 3D workspace room, the processor may render an active user cursor associated with each user, accessing the multi-user 3D workspace room, and details of the each user adjacent to the associated active user cursor, wherein the details of the each user move together with movement of the associated active user cursor. Furthermore, in response to receiving a user input indicative of annotating the 3D object, the processor may activate a tool, on the user interface, that causes rendering an annotation indicator, replacing the details of the user, adjacent to the active user cursor associated with the user.

According to another embodiment, a method for providing an interactive three-dimensional (3D) workspace environment on a computing device is disclosed. The method may include receiving a user input indicative of selection of one of a single-user 3D workspace room and a multi-user 3D workspace room, and displaying, on a display unit of the computing device, a 3D workspace, with a depth effect, based on the selected 3D workspace room. The method may further include receiving a user input indicative of importation of, from a memory of the computing device or from an external computing device, a 3D object file indicative of a 3D object, and displaying, on the display unit, the 3D object in the 3D workspace. The method may further include receiving, in a annotation window displayed on the display unit of the computing device, a user input to annotate the display 3D object in the 3D workspace. The user input, to annotate the display 3D object, may include embedding at least one of a text, one or more images, one or more videos, one or more files, one or more citations associated with the text, or one or more metadata tags in the annotation window.

According to yet another embodiment, a non-transitory computer-readable medium comprising instructions for providing an interactive three-dimensional (3D) workspace environment is disclosed. The instructions, when executed by a processor of a computing device, cause the processor to: receive a user input indicative of selection of one of a single-user 3D workspace room and a multi-user 3D workspace room, render a 3D workspace, with a depth effect, based on the selected 3D workspace room, and provide a prompt to a user to import a 3D object file indicative of a 3D object, the 3D object being displayed in the 3D workspace, and 3D object file being imported from the memory or an external computing device. The instructions may further cause the processor to render a user interface for the user to interact with the rendered 3D object in the 3D workspace. In response to receiving the user input indicative of the single-user 3D workspace room, the processor may render an active user cursor and details of the user, accessing the single-user 3D workspace room, adjacent to the active user cursor, such that the details of the user move together with the movement of the active user cursor. Further, in response to receiving the user input indicative of the multi-user 3D workspace room, the processor may render an active user cursor associated with each user, accessing the multi-user 3D workspace room, and details of the each user adjacent to the associated active user cursor, such that the details of the each user move together with movement of the associated active user cursor. Furthermore, in response to receiving a user input indicative of annotating the 3D object, the processor may activate a tool, on the user interface, that causes rendering an annotation indicator, replacing the details of the user, adjacent to the active user cursor associated with the user.

Still other aspects, features, and advantages of the invention are readily apparent from the following detailed description, simply by illustrating a number of particular embodiments and implementations, including the best mode contemplated for conducting the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 illustrates components of one embodiment of an environment in which the present disclosure may be practiced.

FIG. 2 illustrates a block diagram of an electronic device that can implement one or more aspects of an apparatus, system, and method for providing interactive three-dimensional (3D) workspace environment, in accordance with some embodiments of the present disclosure.

FIG. 3 illustrates a user interface implemented by the system for a single-user 3D workspace, in accordance with some embodiments.

FIG. 4 illustrates the user interface of FIG. 3 implemented by the system and configured to initiate annotations to the 3D object, in accordance with some embodiments.

FIG. 5 illustrates the user interface of FIG. 3 implemented by the system and configured to attach an annotation label to the 3D object, in accordance with some embodiments.

FIG. 6 illustrates the user interface of FIG. 3 implemented by the system and configured to add multimedia to the annotation window, in accordance with some embodiments.

FIG. 7 illustrates the user interface of FIG. 3 implemented by the system and configured to perform multimedia functions, in accordance with some embodiments.

FIG. 8 illustrates the user interface of FIG. 3 implemented by the system and configured to add text to an annotation, in accordance with some embodiments.

FIG. 9 illustrates the user interface of FIG. 3 implemented by the system and configured to add an annotation label, in accordance with some embodiments.

FIGS. 10-12 illustrate the user interface of FIG. 3 implemented by the system at different stages of adding an image to an annotation are illustrated, in accordance with some embodiments.

FIGS. 13-14 illustrate the user interface of FIG. 3 implemented by the system showing different stages of adding a video to an annotation, in accordance with some embodiments.

FIGS. 15-16 illustrate the user interface of FIG. 3 implemented by the system showing different stages of adding a file to an annotation, in accordance with some embodiments.

FIG. 17 illustrates the user interface of FIG. 3 implemented by the system and configured for reading a file associated with the annotations, in accordance with some embodiments.

FIG. 18 illustrates the user interface implemented by the system and showing an annotation panel for performing one or more operations, in accordance with some embodiments.

FIG. 19 illustrates the user interface of FIG. 3 implemented by the system and configured to apply filters in the annotation panel, in accordance with some embodiments.

FIG. 20 illustrates a user interface implemented by the system for a multi-user 3D workspace room, in accordance with some embodiments.

FIGS. 21-23 illustrate the user interface implemented by the system and showing different stages of performing multi-user comment function on the annotations, in accordance with some embodiments.

FIG. 24A illustrates a flowchart of a method of providing an interactive three-dimensional (3D) workspace environment on a computing device, in accordance with some embodiments.

FIG. 24B illustrates a flowchart of a method of adding a comment on an annotation made by another user, in accordance with some embodiments.

### DETAILED DESCRIPTION

Examples of a system, method, and computer program for generating feature data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity. Any process described in this application may be performed in any order and may omit any of the steps in the process. Processes may also be combined with other processes or steps of other processes.

Conventional instructional methodologies, despite instructors' intent to facilitate student success, may inadvertently impede the development of higher-order cognitive skills. For example, “Bloom's Taxonomy” provides a structured classification of learning objectives, including the hierarchical cognitive processes of Remembering, Understanding, Applying, Analyzing, Evaluating, and Creating. However, when learning objectives are misaligned with pedagogical strategies and assessment methodologies, students may be unable to effectively achieve the intended learning outcomes. Existing course structures often emphasize lower-tier cognitive skills, such as remembering and understanding, but underutilize objectives directed toward creative and critical thinking.

In traditional humanities instruction, pedagogical approaches typically integrate lectures with class discussions. However, such methods, even when incorporating student participation, often fail to provide adequate opportunities for students to actively engage in skill development. Instructors may either employ one-way communication or facilitate controlled discussions in which only a limited number of students participate at any given time. Further, it is observed that assessment methodologies frequently fail to align with learning objectives. For example, students who passively absorb lecture material over an academic term are often required to demonstrate critical thinking skills through an extensive, single-topic research paper. However, without incremental practice in analytical and synthesis-based tasks, students may struggle to transition into higher-order cognitive processing. Substantial evidence has been afforded by research-based studies that indicates that not all students possess the innate ability to critically evaluate and synthesize information without structured practice. Therefore, existing pedagogical frameworks that rely primarily on lectures, controlled discussions, and research papers may not be conducive to fostering critical thinking skills.

Similarly, large lecture-based courses frequently assess students through midterm and final examinations that primarily require recall and descriptive responses. These assessments may not fail in facilitating deeper analytical engagement with the socio-historical, cultural, or contextual nuances influencing a given subject. Without structured opportunities and appropriate tools, students are unable to cultivate essential critical thinking competencies. Thus, it is a challenge to enable students to externalize, examine, and refine their understanding of course material while actively engaging in inquiry-based and research-driven learning.

The present disclosure provides for techniques for enabling instructors to create an interactive and experiential learning environment where students can systematically organize their knowledge, identify information gaps, and engage in collaborative peer-driven feedback. By integrating the proposed 3D modelling annotation platform into humanities and social sciences curricula, the system provides virtual access to museum artifacts or heritage sites that may otherwise be inaccessible for in-person study. Additionally, the techniques offer a risk-free, interactive environment for evaluating 3D scans of real-world artifacts without the potential for physical damage.

The techniques further facilitate a structured practice framework, allowing students to identify and annotate specific components of an artifact or site, visually organize lecture materials and research findings, assess existing knowledge, and determine areas requiring further inquiry. Further, the techniques enable students to formulate and test hypotheses regarding the function and significance of historical objects or spaces, collaborate with peers to refine historical or contextual interpretations, and provide targeted feedback by commenting on specific annotations within the platform.

The techniques are designed to enhance student engagement, to thereby foster critical thinking, problem-solving skills, and hands-on interaction. Additionally, the techniques allow students to generate a tangible representation of their learning, making their understanding accessible to both instructors and peers. While initially developed for humanities and social sciences education, the techniques may also be adapted for use in other academic disciplines. The techniques can be applied in various fields, such as history, art history, literature, performing and visual arts, sociology, anthropology, archaeology, religious studies, and foreign language acquisition.

A system (implemented via a computing device) and a method are disclosed for enabling students to interact with, for example a web-based, 3D modeling and annotation platform. In an example, the system may be accessible exclusively through a designated website, optimized for use on laptop and desktop computers, tablets, smartphones, virtual-reality headsets, without requiring additional hardware or peripheral devices. Alternatively, the system may be accessible via a mobile application. Users can gain access to the system via an authenticated login mechanism. Upon successful authentication, the system may direct users to a homepage interface, where they select a workspace configuration, including an individual room or a multi-user room. The individual room may provide a dedicated workspace for a single user to annotate and manipulate 3D objects independently. The multi-user room may also serve as a shared virtual workspace with a predefined capacity, such as up to 20 users, subject to server limitations and/or the bandwidth of the network through which devices of multiple users are connected. Multi-user room settings may be configurable by an instructor, allowing for controlled collaboration among participants.

Once logged in, users may interact with the 3D workspace through predefined input actions, which may be configured in user settings. Navigation within the 3D environment may include object rotation by clicking on the object while holding the right mouse button, orbiting around the object by clicking outside the object while holding the left mouse button, and zooming in or out using the scroll wheel. Additionally, users can move objects by selecting a floating menu option, clicking on a cross-arrows icon, and adjusting the object along 3D X/Y/Z axes either manually or by modifying coordinates in a position panel. To stop object movement, users click outside the object to deactivate it.

Further, the system may provide editing functions for annotating, moving, scaling, and adjusting lighting within the 3D workspace. The interface may minimize cognitive load, providing the only necessary tools to facilitate learning objectives while avoiding the complexity associated with commercial 3D editing software. To enable efficient workspace setup, the system may offer predefined 3D room templates, including configurations such as floor-only, floor with one or more walls, or floor with a ceiling. Alternatively, users may construct customized floor plans using predefined walls and floors, which can be modified in terms of dimensions, coordinates, colors, or by applying images in supported formats such as JPG. Additionally, users may import 3D-scanned spaces, such as historical monuments, for annotation purposes.

The system may support importing 3D objects from external sources. Users may acquire 3D objects from online cultural heritage databases, use third-party mobile scanning applications to capture 3D objects in real-world environments, or collaborate with museums and conservators to obtain 3D scans for educational purposes. The system may support file formats such as FBX and GLB, ensuring that textures are embedded within the model without requiring additional modifications. The import process may include downloading a compatible 3D object onto a local drive and utilizing an “Import” function available in the user interface, which automatically processes and integrates the model into the 3D workspace.

The system may include an annotation module, a commenting functionality, and a multi-user collaborative workspace, facilitating interactive learning experiences. To add annotations to a 3D object, the system may provide an edit menu that allows a user to select an annotation function by clicking on an associated tab. Upon selecting the annotation function, the user may click on the 3D object, which generates an annotation window at the selected location. The annotation window may incorporate a multimedia editor, enabling users to input and format text using WSYWIG (What You See Is What You Get) functions. Additionally, users may insert images by selecting a photo icon, triggering an importer that allows file selection from a local drive, wherein the selected image is embedded within the annotation text field. Users may also insert embedded YouTube videos by copying the desired video's URL, selecting a video clip icon, pasting the URL, and embedding a playable video within the annotation box. Furthermore, users may insert hyperlinks by entering and highlighting text, then selecting a link icon, which converts the highlighted text into an active hyperlink. Below the multimedia editor, a citation field is provided, enabling users to enter references for text, images, videos, or links included in the annotation. Citation formatting may be predefined by the instructor based on course requirements.

The system may further include a commenting module, allowing users to reply to annotations within multi-user rooms. This feature enables peer-to-peer feedback and collaborative discussions. To comment on an annotation, a first user may select an annotation created by a second user, causing the annotation multimedia editor to open. The user interface may also provide a comment tab in the WSYWIG menu. Upon selection of the comment tab, a comment panel may be displayed adjacent to the annotation window. The first user may then enter text, insert images, embed videos, and include hyperlinks within the comment. The comment is automatically saved within the system, and the user may either click outside the annotation to close the panel or minimize it using a designated minimize icon.

The system may further support a multi-user collaborative environment through server-based rooms, allowing multiple users to work within a shared virtual space. Within the multi-user workspace, the user can collaboratively move, scale, and annotate 3D objects to reconstruct the rooms, for example, historical spaces, or create new spaces inspired by literature or other subject matter. The system allows users to import 3D object files, construct virtual spaces using predefined room templates, or import 3D-scanned spaces for annotation and analysis. Additionally, users within a shared workspace can comment on each other's annotations, modify and manipulate 3D objects, and engage in real-time interactions. Further, a history tracking module may record user actions, displaying a chronological log in a side panel, which allows users to revert to the specific saved states. Instructors may be provided with an export functionality, enabling the generation of CSV or Excel files containing user activity data, including usernames, timestamps, annotation labels, annotation content, and comments.

By way of an example, users may add 3D objects and annotations to deepen their understanding of historical artifacts and literature. For example, in an Ancient Roman Art History course, users (e.g., students) may research and annotate 3D scans of museum artifacts, integrating citations and multimedia.

In accordance with some implementations of the present disclosure, first, a user may log into the website or mobile application, and select a multi-user room, which is pre-configured by an instructor with a predefined maximum number of users and a course-specific allocation of rooms. Once logged in, the user may customize the room by selecting a template consisting of predefined structural elements, such as three walls and a floor. The appearance of these elements can be modified by changing wall colors using RGB values and adding images, such as a JPG file, to the floor surface. Next, the user may insert a light source using a dropdown menu in the main interface, where they can select a directional light, adjust its intensity, and reposition it along the X, Y, and Z axes. Objects are then imported into the environment either from a local drive or via a 3D model API, such as “Sketchfab”. When importing from a local drive, the user may download a 3D file in formats like FBX or GLB, select the import function from the menu bar, and upload the file, which is then automatically placed within the environment. Alternatively, when importing via an API, the user may search for the required object, such as a bed, and integrate it into the virtual space.

Annotations may be added by selecting the annotation tool and clicking on a 3D object to generate an annotation box. Labels can be created for various annotation topics, such as identifying materials, discussing historical significance, or referencing literary descriptions. Each annotation may include supporting text, citations, or references to historical documents, ensuring alignment with instructor-defined citation formats like MLA. Additionally, users can interact within the multi-user room, moving and scaling objects while viewing other users' cursors with username icons instead of avatars.

The history tracking function may enable users to review past actions within the server room, displaying the username, timestamp, and type of modification. This function may also allow users to revert the environment to a previous state at a specific time. Furthermore, users can comment on annotations created by their peers by clicking on an annotation label, opening a comment panel, and adding text, images, hyperlinks, or other media. Saved comments may display the contributing user's icon next to the content. Finally, instructors may have the capability to export student activity data, in CSV or Excel format, including usernames, timestamps, annotations, and user-generated comments, allowing for structured assessment and review.

The system may provide for an interactive 3D workspace environment where an individual user may be presented with a screen, upon logging into the website or the mobile application. The environment may display a 3D workspace which can be maximized to fill the display, and a workspace editor menu. The user may be enabled to import a 3D object file from their local drive into the 3D workspace. The 3D object may be manipulable within the environment, where the user can move, rotate, and scale the object as required using the floating editor tool. The workspace editor menu may include a quick action feature for allowing users to easily add annotations to the 3D object, enhancing the object with relevant information or commentary. In addition to the workspace editor menu, the system may feature an annotation window which may list all active or hidden annotations related to those objects.

The annotation window may further include a label feature which automatically appears with every annotation and remains oriented towards the user, ensuring visibility regardless of the user's viewpoint. The labels may not be constrained by the number of annotations, and any number of annotations can be associated with an object. Additionally, any number of objects may exist within the 3D workspace, each potentially with an unlimited number of annotations.

The system may further include an annotation list which may display all active and hidden annotations. Active annotations may be linked with an annotation label, a multimedia annotation editor, and an annotation editor which remains editable and visible to the user. Passive annotations—which are not currently being edited or engaged with—can be toggled off from view by the user, though this function is not explicitly shown in the interface. Furthermore, an annotation position editor may allow users to move active annotations in the 3D environment by adjusting their X, Y, and Z coordinates, providing precise control over annotation placement within the virtual space. The system also may include a multimedia editor offering enhanced multimedia capabilities for annotations, which can be accessed independently of the annotation window.

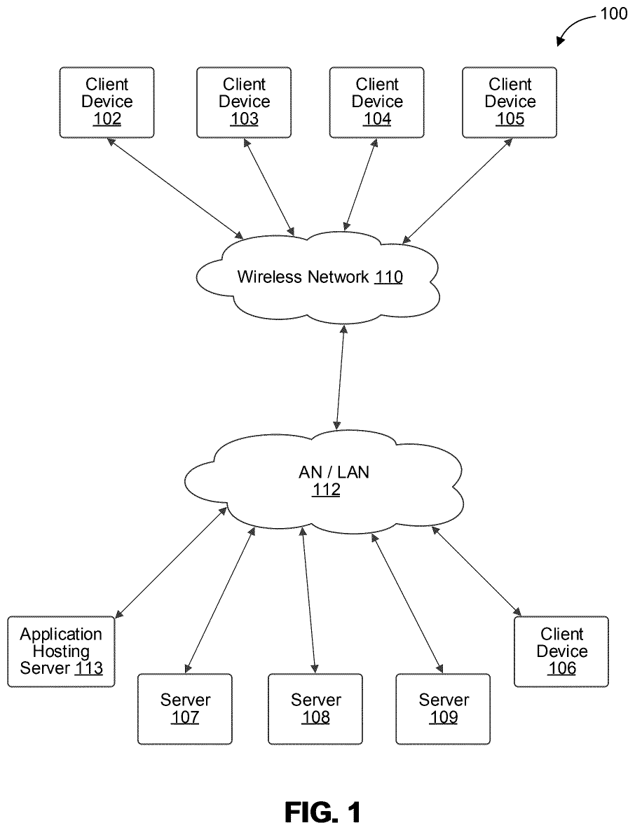

FIG. 1 illustrates components of one embodiment of an environment in which the present disclosure may be practiced. Not all of the components may be required to practice the present disclosure, and variations in the arrangement and type of the components may be made without departing from the spirit or scope of the present disclosure. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. The client devices 102-106 may include, for example, at least one of desktop computers, laptop computers, set top boxes, tablets, cell phones, smart phones, smart speakers, wearable devices (such as the Apple Watch, virtual-reality headsets) and the like. Servers 107-109 can include, for example, one or more application servers, content servers, search servers, and the like. FIG. 1 also illustrates application hosting server 113 which may operate as the computing device of the present subject matter for providing an interactive three-dimensional (3D) workspace environment to one or more users through their respective client devices 102-106 and/or other servers 107-109.

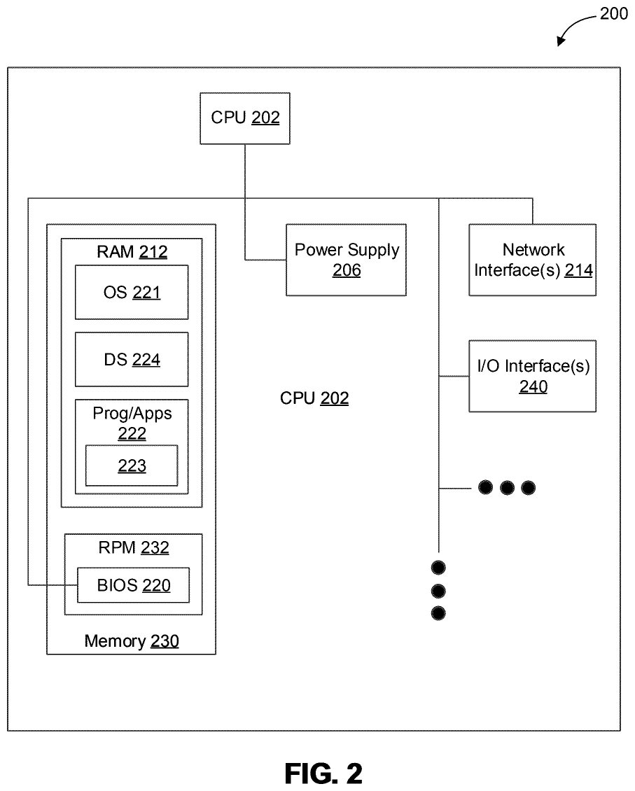

FIG. 2 illustrates a block diagram of an electronic device 200 that can implement one or more aspects of an apparatus, system, and method for providing an interactive three-dimensional (3D) workspace environment, according to one embodiment of the present disclosure. Instances of the electronic device 200 may include servers, e.g., servers 107-109, and client devices, e.g., client devices 102106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be frilly embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software, and other tools necessary to implement or facilitate methods and systems according to embodiments of the present disclosure. The elements may exist on a single computer or be distributed among multiple computers, servers, devices, or entities.

The power supply 206 contains one or more power components and facilitates the supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wiring or wireless communication with other devices on a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as servers may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system, and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone, or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices for example, as may be used in an example apparatus, system and method implementing the Engine, may run a variety of operating systems, including personal computer operating systems such as Windows, iOS or Linux, and mobile operating systems such as iOS, Android, Windows Mobile, and the like.

Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2^{nd} (2G), 3^{rd} (3G), 4^{th} (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network. Embodiments of the present disclosure include apparatuses, systems, and methods implementing the Engine. Embodiments of the present disclosure may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In an embodiment, the system may receive, process, generate and/or store time series data. The system may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte encoded object data.

Disclosed herein are systems and methods facilitating enhanced dynamic three-dimensional computerized object generation and presentation. The system may be generated via a web application and/or an API. In an embodiment, the system may be accessed via a mobile phone web browser, such that said system is accessible via the client devices 102-106. In another embodiment, the user may access the system through virtual-reality headsets (e.g., Apple Vision Pro, Meta Quest 2, etc.), such that the user may interact with the system virtually through said headset. In said embodiments, the user may export the system to a mobile third-party 3D viewer application, including, but not limited to, Microsoft's 3D Viewer. In a further embodiment, the system may provide a hands-on learning experience for one or more students. Additionally, such a system may enhance learning of the one or more students via the hands-on learning experience. In yet a further embodiment, the system may improve the development of the one or more students' critical thinking skills.

The following disclosure of systems and methods facilitating enhanced dynamic three-dimensional computerized object generation and presentation (the “system”) herein exemplifies the usage of said system for course offerings within the liberal arts (e.g., humanities, philosophy, history, etc.). However, those of skill in the art will appreciate that this system can be utilized for course offerings and/or practical applications in other fields, including but not limited to, the fields of architecture, engineering, law, mathematics, medicine, real estate, and science.

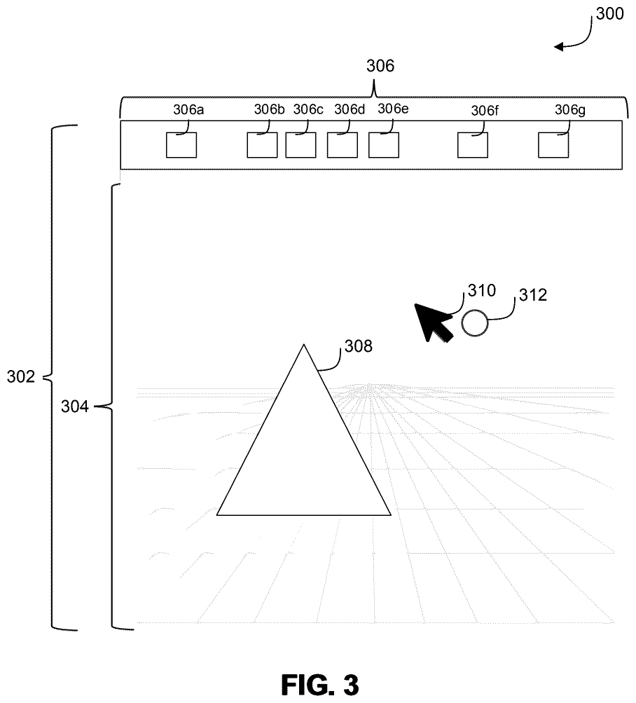

Referring now to FIG. 3, a user interface 300 implemented by the system for a single-user 3D workspace room is illustrated, in accordance with some embodiments. For example, the user interface 300 may be displayed upon a display unit of client devices 102-106. For example, the devices 102-106 (also referred to as “computing devices”) may include a server, such that a processor is communicatively coupled with a user device to receive the user input via the user device. The user device may further provide the prompt to the user device and render a 3D workspace with the 3D object 308 therein. Further, the user interface 300 may display on a display unit of the user device. The computing device may include a smartphone, a tablet, or a virtual-reality (VR) headset. It should be noted that, during operation, the user interface 300 may be rendered for the user to interact with a rendered 3D object in a 3D workspace 304, as will be described in the subsequent sections.

The user interface 300 may include at least one three-dimensional (3D) workspace 304. The 3D workspace 304 may be rendered corresponding to a 3D workspace room 302, in response to receiving a user input indicative of selection of a single-user 3D workspace room or a multi-user 3D workspace room. Accordingly, the 3D workspace 304 may be rendered with a depth effect, based on the selected 3D workspace room. In the implementation shown in FIG. 3, the 3D workspace 304 is rendered in response to receiving a user input indicative of selection of the single-user 3D workspace room 302 (In context of FIG. 3, terms “3D workspace room 302” and “single-user 3D workspace room 302” may be used interchangeably).

In some embodiments, the 3D workspace 304 may be rendered based on a 3D workspace template. To this end, a user input indicative of the 3D workspace template may be received from the user. In some implementations, the user input indicative of the 3D workspace template may be based on an image corresponding to the 3D workspace template. By way of an example, the 3D workspace template may include a floor, a floor with at least one wall, a floor with at least one wall and a ceiling, a floor with at least two partitioning walls, or a floor with at least two partitioning walls and a ceiling. Further, a 3D workspace file corresponding to the 3D workspace template may be imported from the memory or from an external computing device. The 3D workspace template may be rendered, from the imported 3D workspace file, on the 3D workspace 304.

In some embodiments, the 3D workspace 304 may be configured to be rotated in any direction, or rotated along the x, y, or z-axis, or scaled proportionally, or have images added to its surfaces, or have its colors modified, in response to a corresponding user input. For example, in response to an associated user input, the 3D workspace may be moved at least in one of an up-direction, a down-direction, a right-direction, or a left-direction. Further, in response to an associated user input, the 3D workspace may be rotated about at least one of x-axis, y-axis, or z-axis. Furthermore, in response to an associated user input, the 3D workspace may be scaled up or down in size of the 3D workspace proportionally along x-axis, y-axis, and z-axis. Moreover, in response to an associated user input, at least one image may be added on at least one of the floor, one or more of the walls, or the ceiling. Further, in response to an associated user input, the color of at least one of the floor, the at least one wall, the ceiling, or at least one partitioning wall may be changed.

The user interface 300 may further include a workspace editor menu 306. In an embodiment, the 3D workspace 304 and the workspace editor menu 306 may be displayed, via the display, simultaneously. In such an embodiment, the workspace editor menu 306 may be displayed outside of the 3D workspace 304, such that the 3D workspace 304 and the workspace editor menu 306 occupy different portions of the display. For example, the workspace editor menu 306 may be displayed upon a top portion of the display, and the 3D workspace 304 may be displayed upon a bottom portion of the display, or vice versa, as shown in FIG. 3. As another non-limiting example, the 3D workspace 304 may be displayed on a left portion of the display while the workspace editor menu 306 is displayed upon a right portion of the display, or vice versa. In a further embodiment, the 3D workspace 304 and the workspace editor menu 306 may be displayed upon the display individually, such that the 3D workspace 304 or the workspace editor menu 306 occupies an entirety of the display. As a non-limiting example, a user may toggle between the 3D workspace 304 and the workspace editor menu 306.

The user interface 300 may provide a prompt to a user to import a 3D object file indicative of an object. For example, the object may be a 3D object 308. The 3D object file may be imported from a memory or an external computing device. In such an embodiment, the 3D object 308 may be comprised of the 3D object file (e.g., a Filmbox (“FBX”) file, a GL Transmission Format Binary (“GLB”) file, etc.). Additionally, the 3D object 308 may comprise a 3D landscape. For example, the 3D landscape may include a 3D rendering of a room within a building. In such an example, a mobile 3D scanning application may be utilized to scan the room, thus creating the 3D rendering of the room. Upon scanning the room, the 3D rendering of the room may be imported into the 3D workspace 304 via the importation process. In another embodiment, the 3D object file may be imported into the system by the user. As a non-limiting example, the user may acquire the 3D object file from a database (i.e., Sketchfab) and import the said file into the system via an importation process, described in further detail below. In such a non-limiting example, the importation process may open an import menu, wherein the user may select the 3D object file they wish to import, and upon importation, the 3D object may be displayed within the 3D workspace 304. For example, the user may import a 3D rendering of a marble funerary altar of Cominia Tyche into the 3D workspace 304. In an embodiment, the 3D object file the user wishes to import may be preprocessed by the system prior to importation.

In another embodiment, the 3D object 308 imported into the 3D workspace 304 may be constrained by a maximum file size capacity. In such an embodiment, the system may automatically compress a file size of the 3D object 308, such that user may import, via the importation process, a plurality of 3D objects 308 without reaching the maximum file size capacity of the system.

The 3D object 308 may be imported into the 3D workspace 304 via the importation process. In an embodiment, the importation process may employ a first step wherein the user downloads the one 3D object 308 from the database. In an embodiment, the 3D object 308 may be saved to a local drive on the client devices 102-106. A second step of the importation process may include the user logging into the system, wherein the user is directed to at least one of an individual room and a multi-user room. Upon selection of the individual or multiuser room, the importation process may include a third step, wherein the user selects an import function that directs the user to select one of the 3D objects 308. In a fourth step, after selection of the 3D object 308, said 3D object 308 may be displayed within the 3D workspace 304.

Once the 3D object file is imported, the 3D object 308 may be displayed in the 3D workspace 304, as shown in FIG. 3. In an embodiment, the 3D workspace 304 may simultaneously display, via the display, the 3D object 308 and the workspace editor menu 306. The workspace editor menu 306 may be comprised of a plurality of editing options. In an embodiment, the plurality of editing options may enable the user to interact with the 3D object 308. In such an embodiment, the plurality of editing options may enable the user to move, rotate, or change a scale of the 3D object 308. For example, the user may move the 3D object 308 along at least one of an X-axis, a Y-axis, and a Z-axis, within the 3D workspace 304, via the plurality of editing options. In another example, the user may rotate the 3D object 308 along at least one of the X-axis, Y-axis, and Z-axis, within the 3D workspace 304, via the plurality of editing options. In yet another example, the user may change the scale of the 3D object 308 via the plurality of editing options, such that the size of the 3D object 308 may be increased and/or decreased, within the 3D workspace 304.

In particular, as shown in FIG. 3, the plurality of editing options may include an import tab 306a, a select tab 306b, a move tab 306c, a rotate tab 306d, a scale tab 306e, an annotate tab 306f, and an annotation panel tab 306g. The import tab 306a may allow the user to import a 3D model file from the local drive, enabling it to be loaded into the 3D workspace 304. The select tab 306b may enable the user to choose specific 3D model files or individual objects within a file, with the flexibility to select either single or multiple objects as needed. The move tab 306c may activate a tool that allows the user to move the 3D object 308 vertically or horizontally, with movement restricted along the X, Y, or Z axes. The rotate tab 306d may provide functionality to rotate the 3D object 308 in a 360-degree circular motion along any of the X, Y, or Z axes. The scale tab 306e may allow the user to proportionally expand or condense the 3D object 308 along the X, Y, and Z axes simultaneously. For adding descriptive elements, the annotate tab 306f may activate a tool that enables the user to annotate the 3D object 308 directly. The annotation panel button 306g may open a panel where the user can view and edit selected annotations, streamlining the annotation management process.

In an embodiment, the user may utilize at least one of a keyboard, a mouse, a touchpad, a touchscreen, or any other suitable device to interact with the 3D object 308. As a non-limiting example, the user may, via the plurality of editing options, move, rotate, and/or change the scale of the marble funerary altar of Cominia Tyche within the 3D workspace 304. In a further embodiment, the plurality of editing options may enable the user to create an annotation, described in more detail below. In such an embodiment, the user may select one of the 3D object 308 they wish to annotate, in case multiple 3D objects are being displayed.

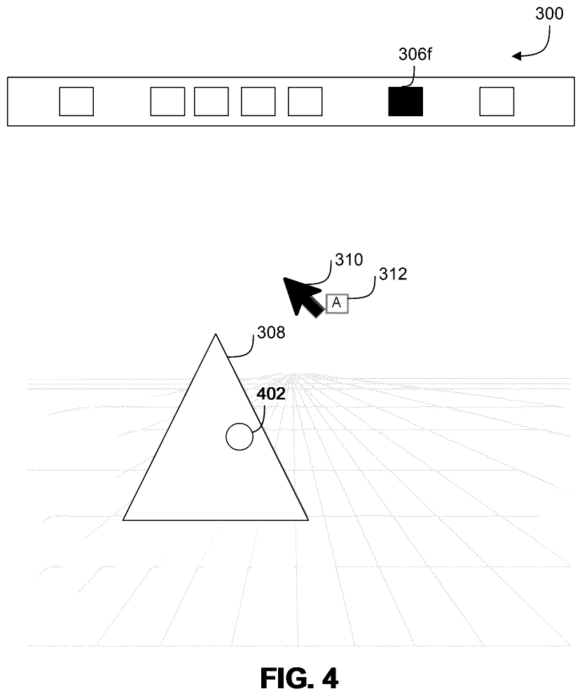

In an embodiment, the 3D object 308 may comprise an underlying structure. For example, the structure may be a wireframe or a mesh comprised of polygons. For example, when two lines intersect, it forms a single point. The single point may be assigned coordinates on at least one of the X, Y, and Z axes. Further, upon importation of the 3D object 308 in the 3D workspace 304, via the importation process, an annotation (e.g., annotation point 402; refer FIG. 4) may recognize at least one of the wireframe and the mesh comprised of polygons. In such an embodiment, the user may interact with the 3D object 308, and upon the interaction, the annotation may attach to the single point on the 3D object 308. Creation of the annotation may be proscribed in the 3D workspace 304 in the absence of the 3D object 308.

During operation, when the user input is received indicative of the single-user 3D workspace room 302, an active user cursor 310 and user details 312 may be rendered, accessing the single-user 3D workspace room 302. In some example implementations, the user details 312 may include a user's profile image. Further, for example, as shown in FIG. 3, the user details 312 may be rendered adjacent to the active user cursor 310, such that the user details 312 may move together with movement of the active user cursor 310. As will be described in detail in the subsequent sections of this disclosure, the user interface may enable rendering of an annotation indicator for replacing the user details 312, in response to receiving a user input indicative of annotating the 3D object 308.

FIG. 4 illustrates the user interface 300 implemented by the system and configured to initiate annotations to the 3D object 308, in accordance with some embodiments. As mentioned above, the user interface 300 may be displayed upon the display of client devices 102-106, to enable the user to interact with the rendered 3D object 308 in the 3D workspace 304.

In order to begin the annotation process, the user may click on the annotate tab 306f. In response to the user clicking, the annotate tab 306f may change color to indicate it is active. Once activated, the active user cursor 310 may change to display an indicator ‘A’, signifying that annotation mode is on. While this mode is active, the user's profile image may temporarily disappear from the interface. In other words, the user details 312 may now change to display the indicator ‘A’. It should be noted that the user's profile image may be set, by default, to appear when the user is interacting with the user interface 300.

The user may then click anywhere on the 3D object 308 (rendered via the corresponding imported 3D model file). In some implementations, at this stage, only a textured exterior of the 3D object 308 may be visible, while its underlying polygon skeleton remains hidden. When the user clicks a specific point on the 3D object 308, the active user cursor 310 may automatically connect to a single vertex within the framework of the 3D object 308. Further, upon clicking, an annotation point 402 may appear at the selected location on the 3D object 308, indicating that the vertex is now ready for annotation. In other words, the annotation point 402 may be displayed, upon receiving a user input indicative of selection of a point on the 3D object 308. This annotation point 402 confirms to the user that the user can proceed with adding annotations (i.e., notes or labels) to the annotation point 402.

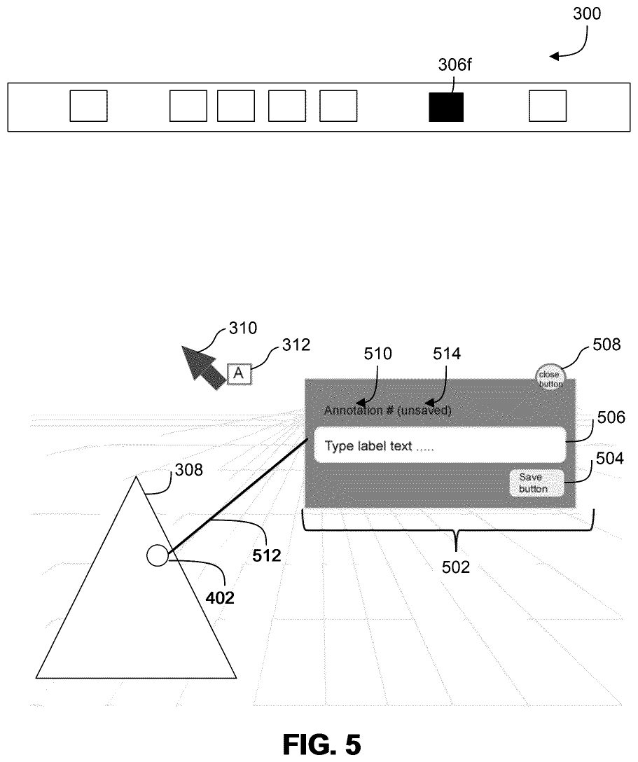

FIG. 5 illustrates the user interface 300 implemented by the system and configured to attach an annotation label to the 3D object 308, in accordance with some embodiments. As mentioned above, the user interface 300 may be displayed upon the display of client devices 102-106, to enable the user to interact with the rendered 3D object 308 in the 3D workspace 304. The annotation point 402 may mark the starting position for adding annotations on the 3D object 308.

Upon the user clicking on the annotate tab 306f, an annotation window 502 associated with the selected point on the 3D object 308 may be rendered on the user interface 300, for the user to annotate the 3D object 308. The annotation window 502 may display an annotations list which may include a list of one or more annotations within the 3D workspace 304.

The annotation window 502 may include a multimedia annotation tab to annotate the 3D object with multimedia comprising a text, one or more images, one or more videos, and one or more files, and with one or more citations and one or more metadata tags associated with the multimedia. The annotation window 502 may be the first element that is created in the annotation process. The annotation window 502 may allow the user to input text, and serve as a heading for any multimedia annotations that may be added later. Until saved by the user, the annotation may remain unsaved and may be identified by an annotation 510. The annotation 510 may be a unique 3D workspace room ID identifier linked to the room 302.

In an embodiment, the workspace editor menu 306 and the annotation window 502 may be simultaneously displayed on the user interface 300. In another embodiment, the user may toggle between the object editor menu 306 and the annotation window 502 such that either the object editor menu 306 or the annotation window 502 may be displayed at a time. As such, in some example implementations, the annotation window 502 may include at least one of; the 3D workspace room ID 510 (may also be represented as “annotation #” 510) and an annotation unsaved indicator or an annotation saved indicator 514. The annotation unsaved indicator or an annotation saved indicator 514 may indicate whether the annotation performed by the user is saved or not.

When the annotation point 402 is activated, a line 512 may appear, visually connecting the annotation point 402 to the annotation window 502. The user may enter text for the heading in a text-annotation field 506. For example, the text-annotation field 506 may have a maximum predetermined character limit.

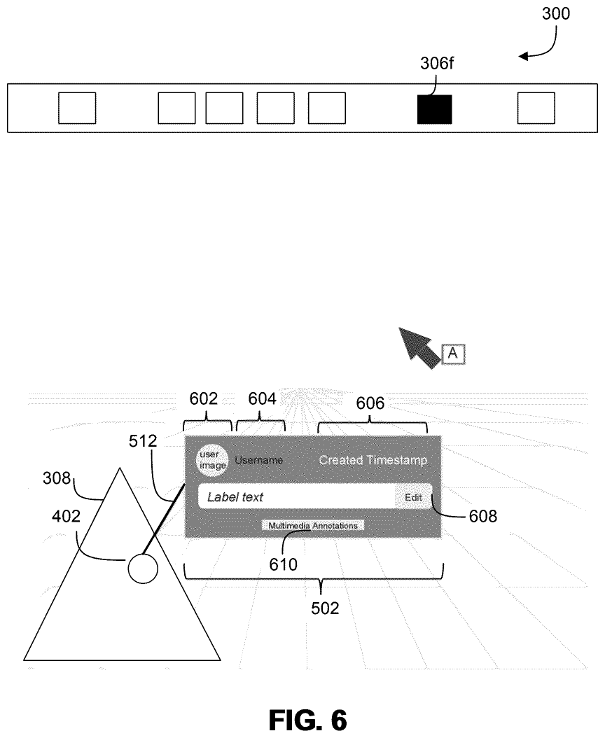

The annotation window 502 may further include an annotation saving tab 504, an annotation closing tab 508 (also referred to as “Close button” 508), details (604; refer FIG. 6) of the user annotating the 3D object 308, or a timestamp (606; refer FIG. 6) recording a start time of rendering of the annotation window or of a latest time of saving of the annotation window. For example, the details of the user may include a username associated with the user. The annotation work is not finalized (i.e., saved) until the user clicks the annotation saving tab 504 (also referred to as “Save button” 504). To this end, once the user completes the text input, the user may click the annotation saving tab 504 that will save the annotation and trigger subsequent actions, as outlined in FIG. 6. If the user chooses not to save the changes, the user may click the annotation closing tab 508, which will close the annotation window 502 without saving any input.

FIG. 6 illustrates the user interface 300 implemented by the system and configured to add multimedia to the annotation window 502, in accordance with some embodiments.

As mentioned above, the annotation window 502 may serve as the initial step in the annotation process. At this point, the user may choose to stop with just the text label (as shown in FIG. 5) or continue by adding multimedia content to the annotation. To personalize the annotation, a user profile image 602 may be uploaded (for example, through the account settings, where this option is available). Further, the username 604 of the user annotating the 3D object 308 may be displayed, reflecting the name entered by the user during account creation.

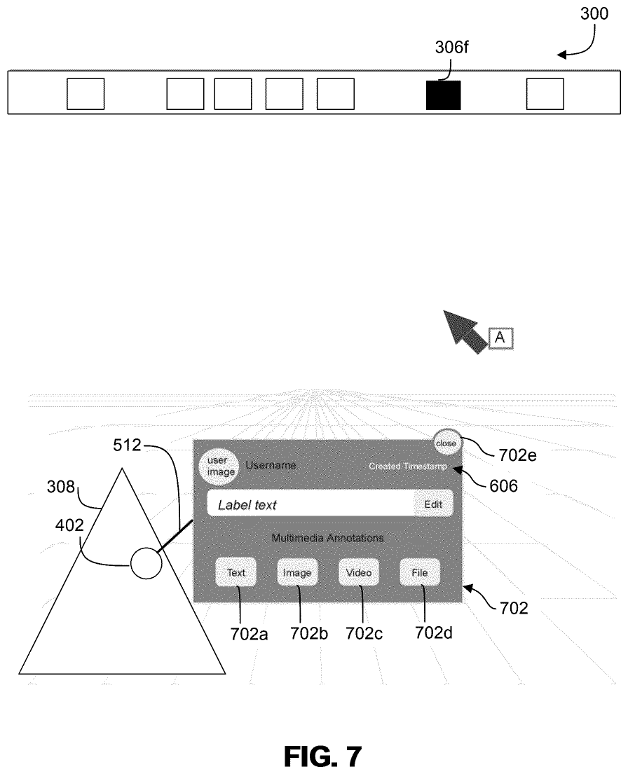

Once the user clicks the annotation saving tab 504, the timestamp 606 may appear, showing the date and time of the annotation in the format “MM/DD/YY HH:MM:SS”. If the user wishes to modify the annotation text, the user may click an edit button 608 to revise the label text provided in the text-annotation field 506. To further enhance the annotation, the user may click a multimedia annotation tab 610, which may open additional options for adding multimedia content, as detailed in FIG. 7.

FIG. 7 illustrates the user interface 300 implemented by the system and configured to perform multimedia functions, in accordance with some embodiments.

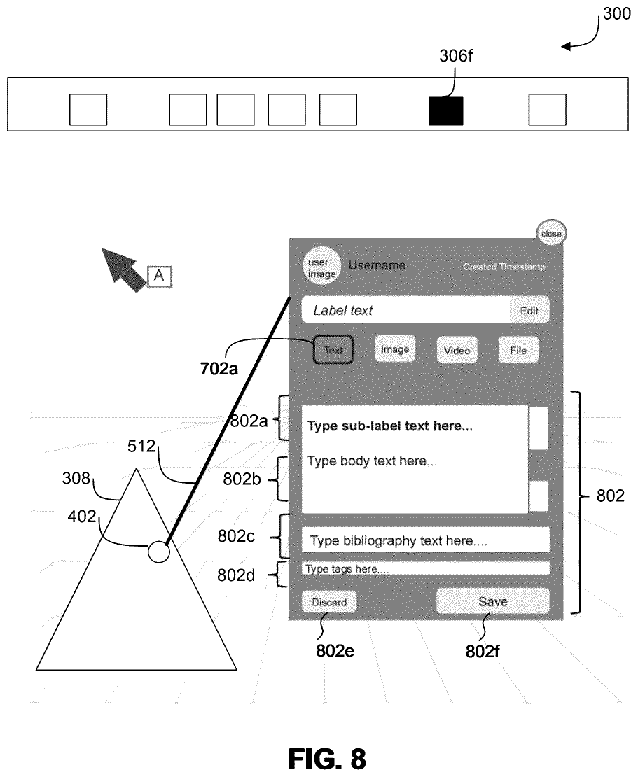

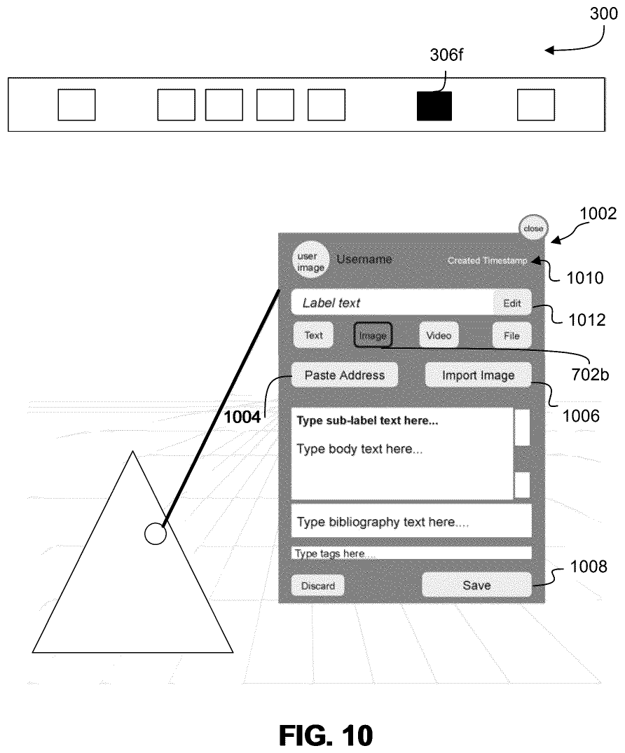

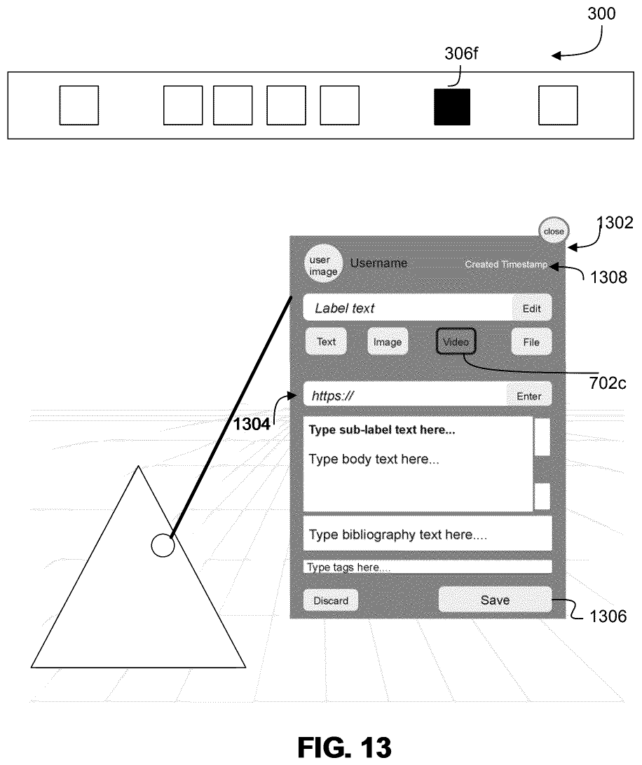

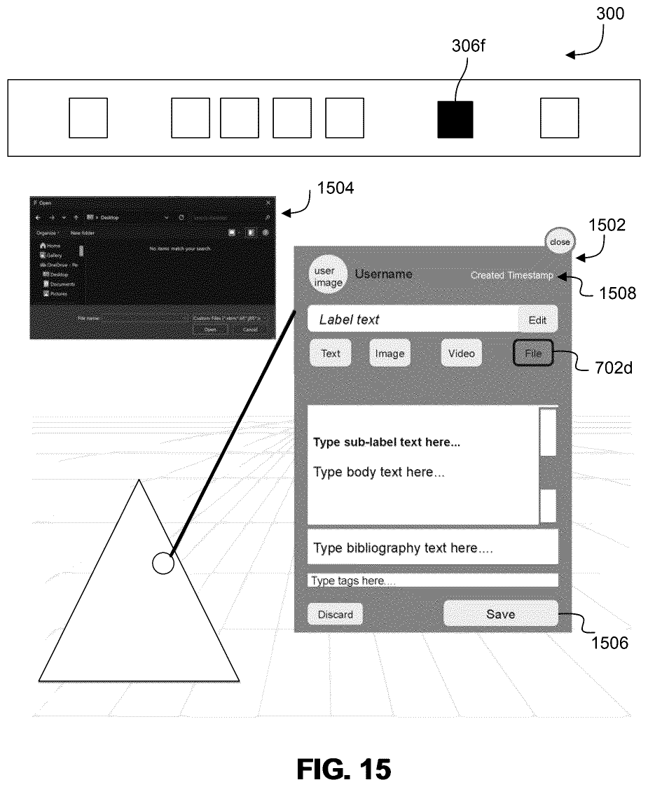

The user interface 300 may display one or more multimedia options 702 for allowing the user to enhance an annotation by adding various types of media. In particular, the one or more multimedia options 702 may include a text tab 702a, an image tab 702b, a video tab 702c, a file tab 702d, and a close button 702e. Clicking the text tab 702a may open ‘Add Text’ popup (as shown in FIG. 8), to enable the user to insert additional text beyond the initial label. Clicking on the image tab 702b may cause to open an ‘Add Image’ popup (as shown in FIG. 10), where users can upload and attach images to the annotation. Further, clicking on the video tab 702c may launch an ‘Add Video’ popup (as shown in FIG. 13), enabling the user to embed video content. Furthermore, clicking the file tab 702d may open an ‘Add File’ popup (as shown in FIG. 15), providing an option to upload and attach supporting documents or files.

If the user decides not to add any multimedia, the user may click the close button 702e, to exit the multimedia options. This action may not affect the previously saved annotation window 502 (as the label text was already saved during the earlier step in FIG. 5).

FIG. 8 illustrates the user interface 300 implemented by the system and configured to add text to an annotation, in accordance with some embodiments.

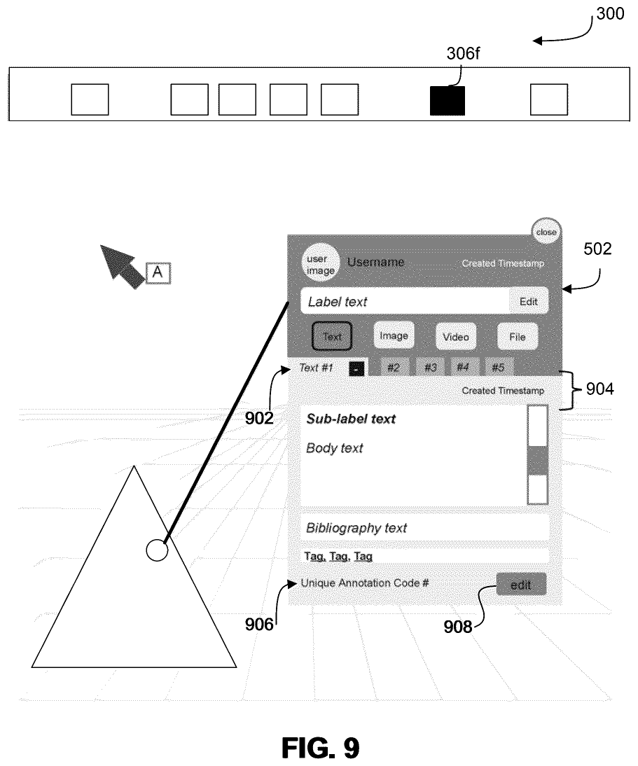

In response to receiving a user input indicative of selection of the multimedia annotation tab 610, the processor may render the text tab 702a in the annotation window 502 on the user interface 300. Further, in response to receiving a user input indicative of selection of the text tab 702a, the processor may render the text-annotation field 802 (also, referred to as “text annotation container 802”) for the user to input a textual description. The textual description, for example, may include a title, a body, and a bibliography text in the text field. Further, the text-annotation field 802 may allow the user to add one or more citations associated with the textual description, or and add one or more metadata tags for the text-annotation field. Furthermore, in response to receiving a user input indicative of selection of the text tab 702a, the processor may render the timestamp 904 (refer FIG. 9) recording a start time of rendering of the text-annotation field 802. Additionally, a unique text-annotation code 906 (refer FIG. 9) and an add new text-annotation field tab may be rendered.

In particular, when the user clicks the text tab 702a (shown in FIG. 7), the text tab 702a may change color and its outline may become bold, indicating that text annotation mode is active. This action may further open the text-annotation field 802, where user can type or paste content into various fields. The text-annotation field 802 may include a sub-label text field 802a, a body text field 802b, a bibliography text field 802c, and a tag text field 802d. The sub-label text field 802a may be a text-only field, where the user can add a secondary heading for the annotation. This serves as an introduction to the body text field 802b (below). A character limit for the sub-label may be set in advance.

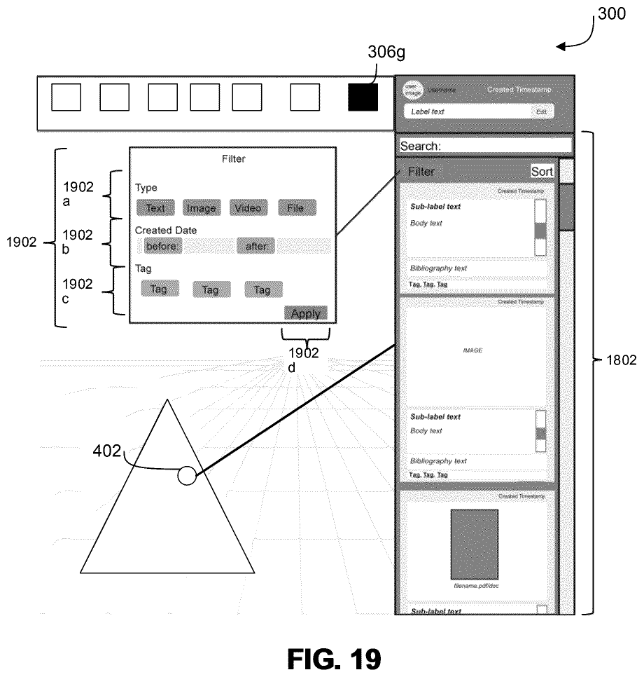

The body text field 802b is the main text field where users can enter detailed information. The body text field 802b may include a scroll bar on the right-hand side for easier navigation when the text exceeds the visible area. There may be no character limit. Further, the user may also be able to paste hyperlinks within the body text field 802b. The bibliography text field 802c may also be text-only field, where users can input references or links. A character limit for this section may be predefined. Further, the user may also be able to paste hyperlinks within the bibliography text field 802c. The tag text field 802d may allow users to categorize their annotations with tags. As later shown in FIG. 19, users can search for tags related to similar completed annotations. In some embodiments, pre-populated tags may also appear, and users can simply click on these to add them to the field.

If the user wants to start over, the user may click a discard button 802e that will clear all the fields in the text-annotation field 802. Once the user has completed the text input, the user may click a save button 802f to save all the entered content. This action may lead to the next steps outlined in FIG. 9.

Referring now to FIG. 9, the user interface 300 implemented by the system and configured to add an annotation label is illustrated, in accordance with some embodiments.

One or more multimedia annotation tabs 902 may be provided to allow the user to organize different types of multimedia annotations, i.e. text, image, video, and file, within the annotation window 502. For example, each annotation type may have up to five tabs, totaling a maximum of twenty tabs per annotation label. The user can click on any tab to view its contents (for example, clicking on Tab #2 may display a second text annotation). To simplify the view, the user can click the black square with a hyphen to minimize the multimedia tabs, showing only the annotation window 502.

When a text annotation is saved using a save button 802f (as shown in FIG. 8), a text annotation timestamp 904 may be generated and displayed. This timestamp 904 may reflect the exact date and time of the save in the format “MM/DD/YY HH:MM:SS”. Additionally, the unique text-annotation code 906 may be created at the time of saving. The unique text-annotation code 906 may be an alphanumeric code that serves as an identifier in the backend database and can be used for easy searching by the user. Further, if any revisions are needed, the user can click an edit button 908 to modify the previously saved text annotation.

Referring now to FIGS. 10-12, the user interface 300 implemented by the system at different stages of adding an image to an annotation are illustrated, in accordance with some embodiments. As shown in FIG. 10, an image-annotation field 1002 is provided which may function similar to the text-annotation field 802 (of FIG. 8). The image-annotation field 1002 may enable the user to add visual content to their annotations.

In response to receiving a user input indicative of selection of the multimedia annotation tab, the may render the image tab 702b in the annotation window 502 on the user interface 300. Further, in response to receiving a user input indicative of selection of the image tab 702b, the processor may render the image-annotation field 1002 for the user to input (e.g., paste) an Internet address of one or more images, or import, from the memory or an external computing device, one or more images. Additionally, the image-annotation field 1002 may enable the user to add a textual description comprising a title, a body, and a bibliography text for the image-annotation field; or add one or more citations associated with the textual description; or add one or more metadata tags for the image-annotation field.

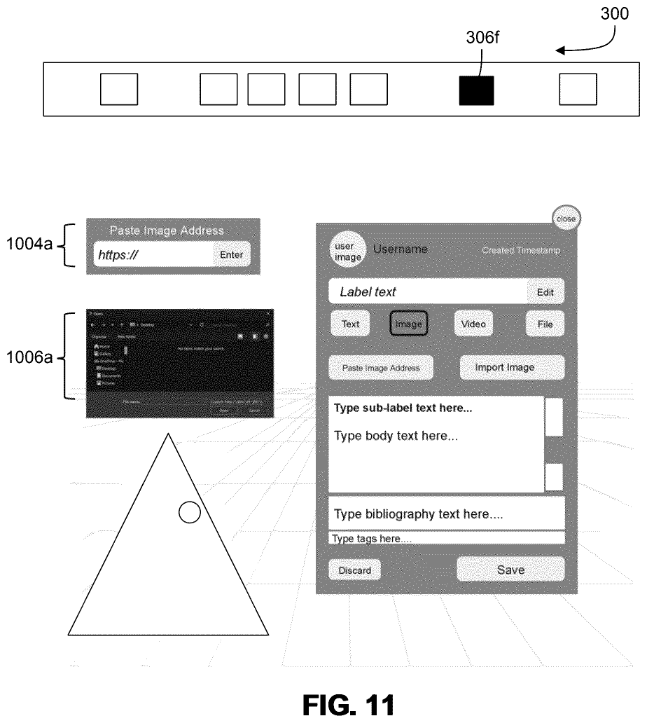

In particular, in order to add an image, the user may have two options: using a paste address button 1004 or using an import image button 1006. Clicking the paste address button 1004 may open a popup window where the user can paste an image URL, for example, a URL copied from the Internet (as illustrated in FIG. 11). Alternatively, the user may click the import image button 1006, which may open a file selection window from the user's local drive (shown in FIG. 11). As such, the above options provide flexibility in sourcing images for annotations, whether from online resources or local storage.

As shown in FIG. 11, once the user has clicked the paste address button 1004, a popup window 1004a may be displayed where the user can paste an image URL, for example, a URL copied from the Internet. Alternatively, once the user has clicked the import image button 1006, a file selection window 1006a may be displayed for selecting the image from the user's local drive.

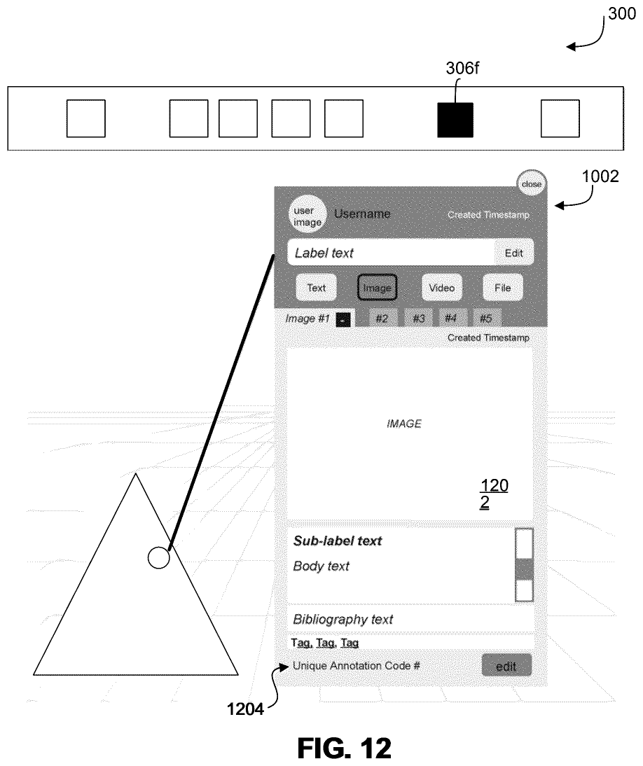

FIG. 12 shows the last stage of adding the image to the annotation. Once the image is selected via either the paste address button 1004 or the import image button 1006, the image may be uploaded and displayed in an image box 1202 within the image-annotation field 1002, as shown in FIG. 12.

When an image annotation is saved using an annotation saving tab 1008 (as shown in FIG. 10), an image annotation timestamp 1010 may be generated and displayed. The image annotation timestamp 1010 may reflect the exact date and time of the save in the format “MM/DD/YY HH:MM:SS”. In response to receiving a user input selecting the annotation saving tab 1008, the processor may embed, in the image-annotation field 1002, the one or more images, the textual description, the one or more citations, and the one or more metadata tags, for viewing by the user. Additionally, a unique image-annotation code 1204 may be created at the time of saving. The unique image-annotation code 1204 may be an alphanumeric code that serves as an identifier in the backend database and can be used for easy searching by the user. Further, if any revisions are needed, the user can click an edit button 1012 to modify the previously saved image annotation.

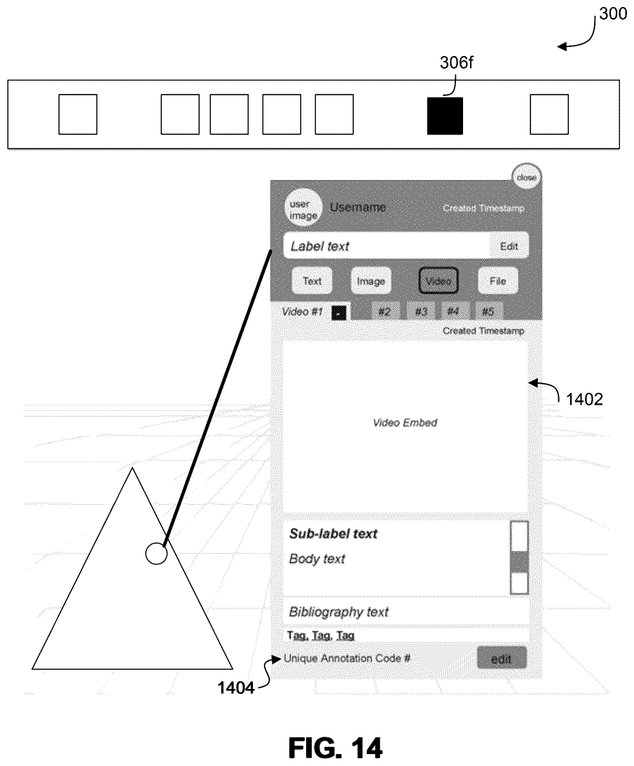

FIGS. 13-14 illustrate the user interface 300 implemented by the system showing different stages of adding a video to an annotation, in accordance with some embodiments.

As shown in FIG. 13, a video-annotation field 1302 may be provided which may operate in a manner similar to the text-annotation field 802 or the image-annotation field 1002. The video-annotation field 1302 may allow users to integrate video content into their annotations.

In response to receiving a user input indicative of selection of the video tab 702c, the processor may render the video-annotation field 1302 for the user to: input an internet address of one or more videos, or import, from the memory or an external computing device, one or more videos. Additionally, video-annotation field 1302 may enable the user to add a textual description including a title, a body, and a bibliography text for the video-annotation field, or add one or more citations associated with the textual description or and to add one or more metadata tags for the video-annotation field.

In particular, in order to add a video, the user may, for example, copy a YouTube link and paste it into an embedded video link field 1304 of the video-annotation field 1302. Once the link is entered, the user may click an enter button 1304a to finalize the process. After this step, the embedded video player will automatically appear, as shown in FIG. 14, allowing the video to be played directly within the annotation.

As shown in FIG. 14, once the user has clicked the enter button 1304a upon entering the link, the YouTube video may appear in a video embed section 1402 of the video-annotation field 1302, along with the YouTube player controls.

When a video annotation is saved using an annotation saving tab 1306 (as shown in FIG. 13), a video annotation timestamp 1308 may be generated and displayed. The video annotation timestamp 1308 may reflect the exact date and time of the save in the format “MM/DD/YY HH:MM:SS”. In response to receiving a user input selecting the annotation saving tab 1306, the processor may embed, in the video-annotation field 1302, the one or more videos, the textual description, the one or more citations, and the one or more metadata tags, for viewing by the user. Additionally, a unique video-annotation code 1404 (shown in FIG. 14) may be created at the time of saving. The unique video-annotation code 1404 may be an alphanumeric code that serves as an identifier in the backend database and can be used for easy searching by the user. Further, if any revisions are needed, the user can click an edit button 1012 to modify the previously saved video annotation.

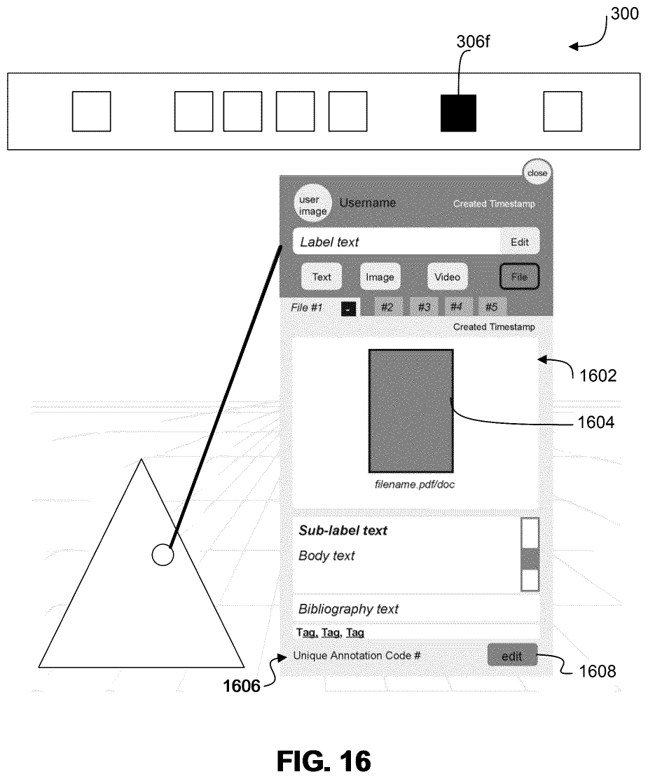

FIGS. 15-16 illustrate the user interface 300 implemented by the system showing different stages of adding a file to an annotation, in accordance with some embodiments.

In response to receiving a user input indicative of selection of the file tab 702d, the processor may render a file-annotation field 1502 for the user to: import, from the memory or an external computing device, one or more files to annotate the 3D object 308. Additionally, the file-annotation field 1502 may enable the user to add a textual description comprising a title, a body, and a bibliography text for the file-annotation field 1502; or add one or more citations associated with the textual description; or add one or more metadata tags for the file-annotation field 1502.

In particular, the file-annotation field 1502 may be provided which may function similar to the text-annotation field 802, enabling users to attach documents to their annotations. To add a file, the user may click the file tab 702d within the multimedia options 702 (as described in conjunction with FIG. 7). This action may automatically open a user's local drive folder window 1504, allowing the user to select a file. In some implementations, PDF and DOC/DOCX file formats may be supported for upload.

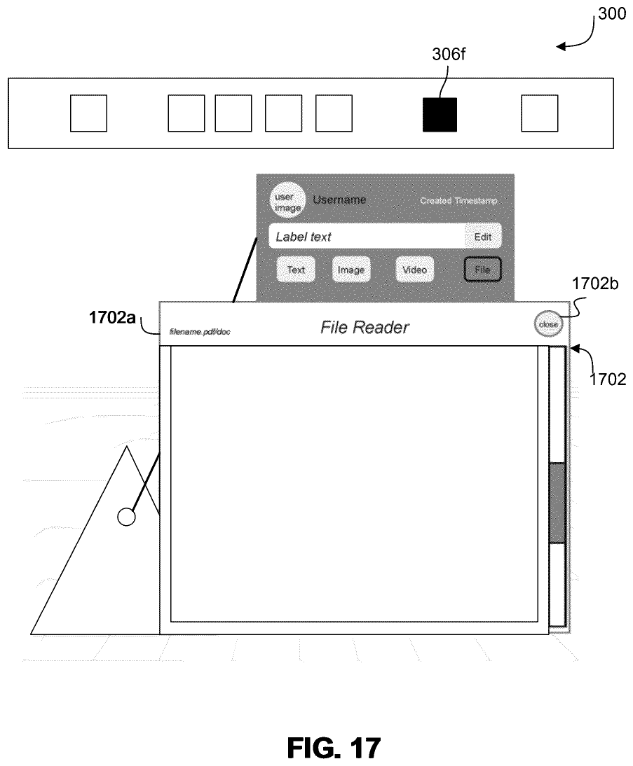

As shown in FIG. 16, once the action of selecting the file is performed, an open file reader section 1602 may be displayed in the file-annotation field 1502; the open file reader section 1602 may display a thumbnail 1604 corresponding to the selected file. The user may, for example, double-click on the thumbnail 1604, to cause the open file reader section 1602 to open the file on the screen (as shown in FIG. 17).

When a file annotation is saved using a file annotation saving tab 1506 (as shown in FIG. 15), a file annotation timestamp 1508 may be generated and displayed. The file annotation timestamp 1508 may reflect the exact date and time of the save in the format “MM/DD/YY HH:MM:SS”. In response to receiving a user input selecting the file annotation saving tab 1506, the processor may embed, in the file-annotation field 1502, the one or more files, the textual description, the one or more citations, and the one or more metadata tags, for viewing by the user. Additionally, a unique file-annotation code 1606 (shown in FIG. 16) may be created at the time of saving. The unique file-annotation code 1606 may be an alphanumeric code that serves as an identifier in the backend database and can be used for easy searching by the user. Further, if any revisions are needed, the user can click an edit button 1608 (shown in FIG. 16) to modify the previously saved video annotation.

FIG. 17 illustrates the user interface 300 implemented by the system and configured for reading a file associated with the annotations, in accordance with some embodiments.

As mentioned above, upon the user double-clicking on the thumbnail 1604, the open file reader section 1602 may open the file on the screen. In some embodiments, the file may be opened in a file reader container 1702. The file reader container 1702 may include a filename 1702a and a close button 1702b. The filename 1702a may indicate the name of the file (i.e., the PDF/DOC/DOCX file). The close button 1702b may be used by the user to close the file reader container 1702, and return to the file annotation.

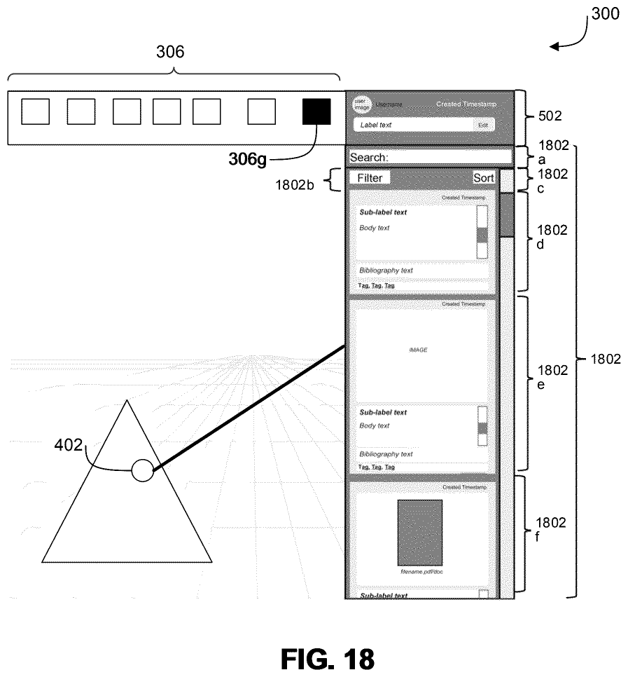

Referring now to FIG. 18, the user interface 300 implemented by the system and showing an annotation panel for performing one or more operations is illustrated, in accordance with some embodiments.

To manage and view annotations, the user begins by clicking the annotation panel tab 306g, which may open an annotation panel 1802. Once opened, the annotation window 502 may shift to position as indicated in FIG. 18, i.e., adjacent to the workspace editor menu 306. The annotation panel 1802 displays all annotations linked to the annotation point 402, arranged in ascending order based on their timestamps. The user can scroll vertically to view the entire list of annotations.

For quick navigation, a search field 1802a may be provided to allow the user to enter keywords to filter results within the annotation panel 1802. In some example implementations, the search may cover labels, sub-labels, body text, tags, and bibliography related to the selected annotation point 402. Additionally, a filter button 1802b may be used to open a pop-up (as shown in FIG. 19) where the user can refine search criteria. A sort button 1802c may enable the user to organize annotations in ascending or descending order based on their timestamp.

The annotation panel 1802 may further include a completed text annotations section 1802d, a completed image annotations section 1802e, and a completed file annotations section 1802f. The completed text annotations section 1802d may display the completed text annotations (refer, FIG. 9); the completed image annotations section 1802e may display completed image annotations (refer, FIG. 12); and the completed file annotations sections 1802f may display completed file annotations (refer, FIG. 16). Although, not shown in FIG. 18, the annotation panel 1802 may also include a completed video annotations section. The structured user interface 300, therefore, ensures efficient annotation management and easy access to specific content.

FIG. 19 illustrates the user interface 300 implemented by the system and configured to apply filters in the annotation panel 1802, in accordance with some embodiments.

To apply filters in the annotation panel 1802, the user may begin by opening a filter pop-up container 1902, which offers various options to narrow down annotations displayed in the annotation panel 1802. For example, the filter pop-up container 1902 may include various buttons, such as a type button 1902a, a created date button 1902b, a tag button 1902c, and an apply button 1902d.

The type button 1902a may allow the user to filter annotations based on their type, i.e., text, image, video, or file. It should be noted that multiple types can be selected simultaneously, such as text and image, to display a combination of annotation formats. The created date button 1902b may provide the option to filter annotations by their creation date. The users can specify whether they want to see annotations created before or after a certain date by entering the date in the DD-MM-YYYY format. The tag button 1902c may display pre-populated tags associated with existing annotations. The user can click on these tags to refine the search results based on specific topics or categories. Once the desired filter criteria are selected, the user may click the apply button 1902d to save and activate the filters, thereby updating the annotations displayed in the panel accordingly.

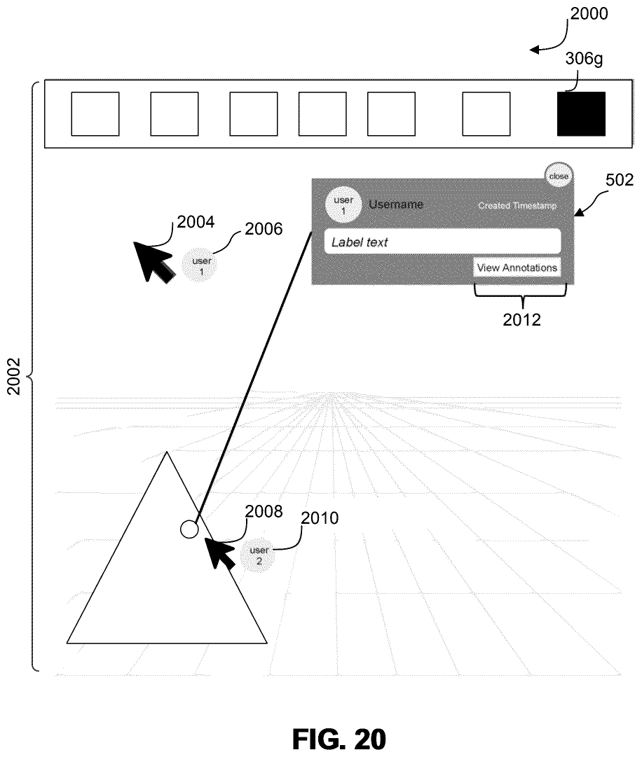

Referring now to FIG. 20, a user interface 2000 implemented by the system for a multi-user 3D workspace room 2002 is illustrated, in accordance with some embodiments. For example, the user interface 2000 may be displayed upon a display of client devices 102-106. During operation, the user interface 2000 may be rendered for the user to interact with a rendered 3D object in a 3D workspace, as will be described in the subsequent sections. Similar to the user interface 300 mentioned above, the user interface 2000 may include at least one 3D workspace, which may be rendered corresponding to a 3D workspace room, in response to receiving a user input indicative of selection of a multi-user 3D workspace room. The 3D workspace may be rendered with a depth effect, based on the selected multi-user 3D workspace room.

In response to receiving the user input indicative of the multi-user 3D workspace room, the user interface 2000 may render an active user cursor associated with each user, accessing the multi-user 3D workspace room 2002, and details of the each user adjacent to the associated active user cursor. The details of the each user may move together with movement of the associated active user cursor. In particular, for a first user, the user interface 2000 may render an active user cursor 2004 accessing the multi-user 3D workspace room 2002, and details of the first user, i.e., first user details 2006 adjacent to the associated active user cursor 2004. The first user details 2006 may move together with movement of the associated active user cursor 2004. For a second user, the user interface 2000 may render an active user cursor 2008 accessing the multi-user 3D workspace room 2002, and details of the second user, i.e., second user details 2010 adjacent to the associated active user cursor 2008. The second user details 2010 may move together with movement of the associated active user cursor 2008.

In the multi-user 3D workspace room 2002, multiple users can collaborate on the same project. The first user may create the room, import the 3D object(s), and add annotations, following the steps outlined in FIGS. 3-19. The second user may join the multi-user 3D workspace room 2002 using a code provided by the first user. Upon entering, the second user may have an ability to import additional 3D objects and create their own annotations, following the same process as shown in FIGS. 3-19.

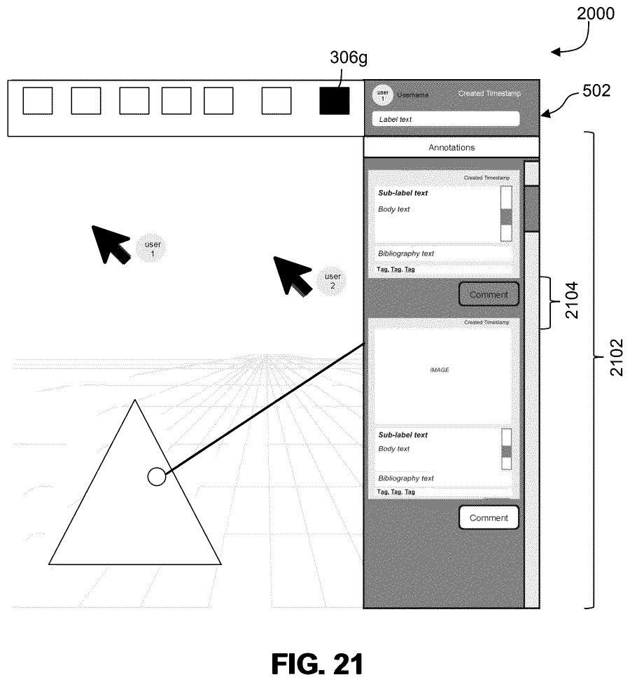

During operation, the first user, accessing the multi-user 3D workspace room 2002, may provide a user input indicative of selection of the annotation window associated with the annotation point on the 3D object selected by a first user. In response to selection of the annotation window, a comments field 2102 (refer FIG. 21) may be rendered, in the user interface 2000, against each annotation in the annotation window. The comments field 2102 may be rendered to receive from the second user a comment on the multimedia and entries embedded in the annotation window associated with the point on the 3D object selected by the first user. The comment may include one or more media including a textual description, an image, a video, a file, a citation, a metadata tag, or a combination thereof. Further, a timestamp indicative of a start time or an end time of the comments field 2102 may be recorded and rendered.

In particular, as shown in FIG. 20, the second user can interact with the first user's annotations by adding comments. To do this, the second user may click on the annotation point 408 created by the first user. This action may open the non-editable annotation window 502, allowing the second user to view the details without making changes. To view all annotations linked to annotation point 408, the second user may click a view annotations button 2012, which may open the comments field 2102 displaying all annotations associated with the selected annotation point 408.

In continuation with FIG. 20, FIGS. 21-23 illustrate the user interface 2000 implemented by the system and showing different stages of performing multi-user comment function on the annotations, in accordance with some embodiments.

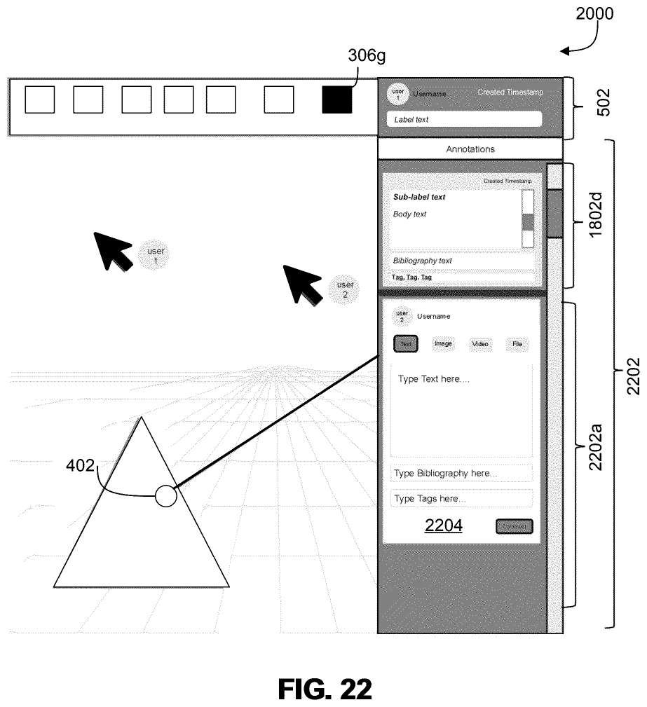

As shown in FIG. 21, the comments field 2102 may be displayed that may allow the second user to view the first user's annotations within their own annotation panel. While the second user can see all of the first user's annotations, however, the second user may not be able to make any edits to the first user's annotations. In order to respond, the second user may click a comment button 2104, which may open an option to add their own multimedia annotations as a comment on the first user's non-editable annotation. The process of adding these comments is described in conjunction with FIG. 22.

As shown in FIG. 22, in the process of adding comments on the annotations, the second user can view the first user's annotation window 502 and respond specifically to the completed text annotation section 1802d of the first user. Both the annotation window 502 and the completed text annotation section 1802d may remain fixed and non-editable. However, all users within the room multi-user 3D workspace room 2002 may be able to view these annotations and contribute their own comments.

A comment annotation panel 2202 may be provided that may resemble the annotation panel shown in FIGS. 3-17, but with the distinction that there are no popups within the three-dimensional workspace environment associated with the multi-user 3D workspace room 2002. Instead, the second user's comments are added directly within this panel.

A comment annotation container 2202a may be provided within which the second user's profile image and username may be displayed, for example, in the top left corner. The second user may select a type of annotation (i.e., text, image, video, or file) they wish to add. After selecting the type, the second user may enter text and/or bibliography references and tags, if necessary. To finalize their input, the second user may click a comment button 2204, to thereby save the annotation response.

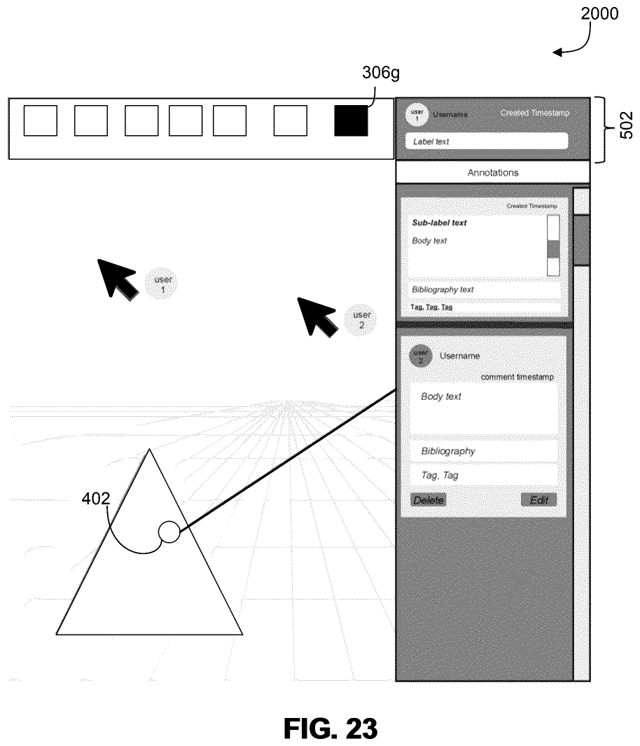

With reference to FIG. 23, in the multi-user 3D workspace room 2002, all the users (i.e. including the second user) can click on the first user's annotation point 402 to access and view the comment annotation panel 2202. Further, the second user may be able to edit or delete their own comments within this panel. However, the annotation window 502 and any multimedia annotations created by the first user will always remain fixed at the top of the comment annotation panel, distinguishing the original annotation from user comments.

Additionally, in some embodiments, a search bar function may be provided, to allow users to search for other users' annotations within the same multi-user 3D workspace room 2002 for easier navigation and collaboration. To this end, one or more user inputs may be received to search the annotation window 502, based on a type of multimedia and entries embedded in the annotation window. Further, one or more user inputs may be received to sort the multimedia and the entries embedded in the annotation window. In response, the multimedia and the entries may be sorted based on timestamps recording a start time of annotation of the 3D object by the user.

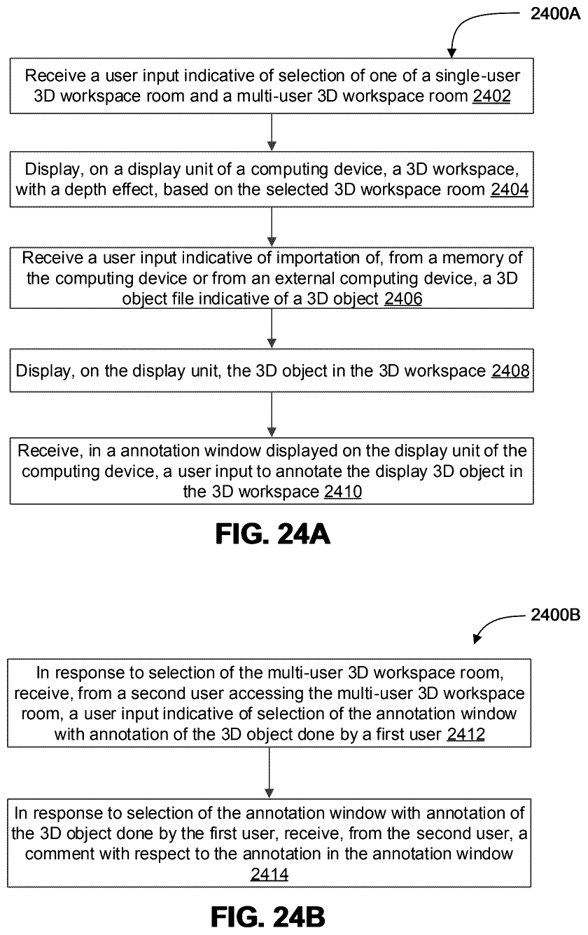

Referring now to FIG. 24A, a flowchart of a method 2400A of providing an interactive three-dimensional (3D) workspace environment on a computing device is illustrated, in accordance with some embodiments of the present disclosure. The method 2400A may be performed, for example, by a processor of the computing device.

At step 2402, receiving, by a, a user input indicative of selection of one of a single-user 3D workspace room and a multi-user 3D workspace room. At step 2404, a 3D workspace 304 may be displayed, with a depth effect, based on the selected 3D workspace room. The 3D workspace 304 may be displayed on a display unit of the computing device.

At step 2406, a user input indicative may be received for a 3D object file indicative of the 3D object 308. The user input may be received for importation of the 3D object file from a memory of the computing device or from an external computing device. At step 2408, the 3D object 308 may be displayed in the 3D workspace 304, via the display unit of the computing device. At step 2410, a user input may be received to annotate the displayed 3D object 308 in the 3D workspace 304. The user input may be received in the annotation window 502 displayed on the display unit of the computing device. The user input may be for annotating the displayed 3D object 308, and may include embedding at least one of a text, one or more images, one or more videos, one or more files, one or more citations associated with the text, or one or more metadata tags in the annotation window. The above steps are already explained in detail, in conjunction with FIGS. 3-19.

FIG. 24B illustrates a flowchart of a method 2400B of adding a comment on an annotation made by another user, in accordance with some embodiments of the present disclosure.

At step 2412, in response to selection of the multi-user 3D workspace room 2002, a user input may be received from a second user accessing the multi-user 3D workspace room 2002. The user input may be indicative of selection of the annotation window 502 with annotation of the 3D object 308 done by a first user.

At step 2414, in response to selection of the annotation window 502 with annotation of the 3D object 308 done by the first user, a comment may be received from the second user, with respect to the annotation in the annotation window. The comment may include one or more media including a textual description, an image, a video, a file, a citation, a metadata tag, or a combination thereof. This is already explained in detail in conjunction with FIGS. 20-23.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computing device for providing an interactive three-dimensional (3D) workspace environment, the computing device comprising:
a processor; and
a memory, coupled to the processor, storing computer-executable instructions which when executed by the processor causes the processor to:
receive a user input indicative of selection of one of a single-user 3D workspace room and a multi-user 3D workspace room;
render a 3D workspace, with a depth effect, based on the selected 3D workspace room;
provide a prompt to a user to import a 3D object file indicative of a 3D object, the 3D object being displayed in the 3D workspace, and 3D object file being imported from the memory or an external computing device; and
render a user interface for the user to interact with the rendered 3D object in the 3D workspace,
wherein, in response to receiving the user input indicative of the single-user 3D workspace room, the processor is to render an active user cursor and details of the user, accessing the single-user 3D workspace room, adjacent to the active user cursor, wherein the details of the user move together with movement of the active user cursor;
wherein, in response to receiving the user input indicative of the multi-user 3D workspace room, the processor is to render an active user cursor associated with each user, accessing the multi-user 3D workspace room, and details of the each user adjacent to the associated active user cursor, wherein the details of the each user move together with movement of the associated active user cursor, and
wherein, in response to receiving a user input indicative of annotating the 3D object, the processor is to activate a tool, on the user interface, that causes rendering an annotation indicator, replacing the details of the user, adjacent to the active user cursor associated with the user.

2. The computing device of claim 1, wherein the processor is to:
receive a user input indicative of selection of a point on the 3D object to be annotated; and
render, on the user interface, an annotation window associated with the selected point on the 3D object for the user to annotate the 3D object, wherein the annotation window comprises:
a multimedia annotation tab to annotate the 3D object with multimedia comprising a text, one or more images, one or more videos, and one or more files, and with one or more citations and one or more metadata tags associated with the multimedia.

3. The computing device of claim 1, wherein the annotation window comprises at least one of:
a 3D workspace room ID;
an annotation unsaved indicator or an annotation saved indicator;
an annotation saving tab;
an annotation closing tab;
the details of the user annotating the 3D object; or
a timestamp recording a start time of rendering of the annotation window or of a latest time of saving of the annotation window.

4. The computing device of claim 2, wherein, in response to receiving a user input indicative of selection of the multimedia annotation tab, the processor is to render:
a text tab in the annotation window on the user interface, wherein, in response to receiving a user input indicative of selection of the text tab, the processor is to render:
a text-annotation field for the user to: input a textual description comprising a title, a body, and a bibliography text for the text field; add one or more citations associated with the textual description; and add one or more metadata tags for the text-annotation field;
a timestamp recording a start time of rendering of the text-annotation field;
a unique text-annotation code; and
an add new text-annotation field tab,
wherein, in response to receiving a user input selecting the annotation saving tab, the processor is to embed, in the text-annotation field, the textual description, the one or more citations, and the one or more metadata tags, for viewing by the user.

5. The computing device of claim 2, wherein, in response to receiving a user input indicative of selection of the multimedia annotation tab, the processor is to render:
an image tab in the annotation window on the user interface, wherein, in response to receiving a user input indicative of selection of the image tab, the processor is to render:
an image-annotation field for the user to: input an internet address of one or more images; import, from the memory or an external computing device, one or more images; add a textual description comprising a title, a body, and a bibliography text for the image-annotation field; add one or more citations associated with the textual description; and add one or more metadata tags for the image-annotation field;
a timestamp recording a start time of rendering of the image-annotation field;
a unique image-annotation code; and
an add new image-annotation field tab,
wherein, in response to receiving a user input selecting the annotation saving tab, the processor is to embed, in the image-annotation field, the one or more images, the textual description, the one or more citations, and the one or more metadata tags, for viewing by the user.

6. The computing device of claim 2, wherein, in response to receiving a user input indicative of selection of the multimedia annotation tab, the processor is to render:
a video tab in the annotation window on the user interface, wherein, in response to receiving a user input indicative of selection of the video tab, the processor is to render:
a video-annotation field for the user to: input an internet address of one or more videos; import, from the memory or an external computing device, one or more videos; add a textual description comprising a title, a body, and a bibliography text for the video-annotation field; add one or more citations associated with the textual description; and to add one or more metadata tags for the video-annotation field;
a timestamp recording a start time of rendering of the video-annotation field;
a unique video-annotation code; and
an add new video-annotation field tab,
wherein, in response to receiving a user input selecting the annotation saving tab, the processor is to embed, in the video-annotation field, the one or more videos, the textual description, the one or more citations, and the one or more metadata tags, for viewing by the user.

7. The computing device of claim 2, wherein, in response to receiving a user input indicative of selection of the multimedia annotation tab, the processor is to render:
a file tab in the annotation window on the user interface, wherein, in response to receiving a user input indicative of selection of the file tab, the processor is to render:
a file-annotation field for the user to: import, from the memory or an external computing device, one or more files to annotate the 3D object; add a textual description comprising a title, a body, and a bibliography text for the file-annotation field; add one or more citations associated with the textual description; and to add one or more metadata tags for the file-annotation field;
a timestamp recording a start time of rendering of the file-annotation field;
a unique file-annotation code; and
an add new file-annotation field tab,
wherein, in response to receiving a user input selecting the annotation saving tab, the processor is to embed, in the file-annotation field, the one or more files, the textual description, the one or more citations, and the one or more metadata tags, for viewing by the user.

8. The computing device of claim 2, wherein the processor is to:
receive from a second user, accessing the multi-user 3D workspace room, a user input indicative of selection of the annotation window associated with the point on the 3D object selected by a first user;
in response to selection of the annotation window, render a comments field, on the user interface, against each annotation in the annotation window to receive from the second user a comment on the multimedia and entries embedded in the annotation window associated with the point on the 3D object selected by the first user, wherein the comment comprise one or more media including a textual description, an image, a video, a file, a citation, a metadata tag, or a combination thereof; and
record and render a timestamp indicative of a start time or an end time of the comments field.

9. The computing device of claim 2, wherein the processor is to:
receive one or more user inputs to search the annotation window based on a type of multimedia and entries embedded in the annotation window; and
receive one or more user inputs to sort the multimedia and the entries embedded in the annotation window, wherein the multimedia and the entries are sorted based on timestamps recording a start time of annotation of the 3D object by the user.

10. The computing device of claim 1, wherein, for rendering the 3D workspace, the processor is to:
receive a user input indicative of a 3D workspace template;
import, from the memory or from an external computing device, a 3D workspace file corresponding to the 3D workspace template; and
render the 3D workspace template, from the imported 3D workspace file, on the 3D workspace, wherein the 3D workspace template comprises one of:
a floor;
a floor with at least one wall;
a floor with at least one wall and a ceiling;
a floor with at least two partitioning walls; or
a floor with at least two partitioning walls and a ceiling.

11. The computing device of claim 10, wherein the user input indicative of the 3D workspace template is based on an image corresponding to the 3D workspace template.

12. The computing device of claim 10, wherein the processor is to receive a user input indicative of at least one of:
movement of the 3D workspace at least in one of an up-direction, a down-direction, a right-direction, or a left-direction;
rotation of the 3D workspace about at least one of x-axis, y-axis, or z-axis;
scaling up or down in size of the 3D workspace proportionally along x-axis, y-axis, and z-axis;
adding at least one image on at least one of the floor, one or more of the walls, or the ceiling; or
changing color of at least one of the floor, the at least one wall, the ceiling, or at least one partitioning wall.

13. The computing device of claim 1, wherein the computing device comprises a server, wherein the processor is communicatively coupled with a user device to receive the user input via the user device, provide the prompt to the user device, and render the 3D workspace, with the 3D object therein, and the user interface to display on a display unit of the user device.

14. The computing device of claim 1, wherein the computing device comprises a smartphone, a tablet, or a virtual-reality headset.

15. A method for providing an interactive three-dimensional (3D) workspace environment on a computing device, the method comprising:
receiving, by a processor of the computing device, a user input indicative of selection of one of a single-user 3D workspace room and a multi-user 3D workspace room;
displaying, by the processor on a display unit of the computing device, a 3D workspace, with a depth effect, based on the selected 3D workspace room;
receiving, by the processor, a user input indicative of importation of, from a memory of the computing device or from an external computing device, a 3D object file indicative of a 3D object;
displaying, by the processor on the display unit, the 3D object in the 3D workspace; and
receiving, by the processor in a annotation window displayed on the display unit of the computing device, a user input to annotate the display 3D object in the 3D workspace, wherein the user input, to annotate the display 3D object, comprises embedding at least one of a text, one or more images, one or more videos, one or more files, one or more citations associated with the text, or one or more metadata tags in the annotation window.

16. The method of claim 15, wherein the method comprises:
in response to selection of the multi-user 3D workspace room, receiving, by the processor, from a second user accessing the multi-user 3D workspace room a user input indicative of selection of the annotation window with annotation of the 3D object done by a first user; and
in response to selection of the annotation window with annotation of the 3D object done by the first user, receiving, by the processor, from the second user a comment with respect to the annotation in the annotation window, wherein the comment comprise one or more media including a textual description, an image, a video, a file, a citation, a metadata tag, or a combination thereof.

17. A non-transitory computer-readable medium comprising instructions which, when executed by a processor of a computing device, cause the processor to:
receive a user input indicative of selection of one of a single-user 3D workspace room and a multi-user 3D workspace room;
render a 3D workspace, with a depth effect, based on the selected 3D workspace room;
provide a prompt to a user to import a 3D object file indicative of a 3D object, the 3D object being displayed in the 3D workspace, and 3D object file being imported from the memory or an external computing device; and
render a user interface for the user to interact with the rendered 3D object in the 3D workspace,
wherein, in response to receiving the user input indicative of the single-user 3D workspace room, the processor is to render an active user cursor and details of the user, accessing the single-user 3D workspace room, adjacent to the active user cursor, wherein the details of the user move together with movement of the active user cursor;
wherein, in response to receiving the user input indicative of the multi-user 3D workspace room, the processor is to render an active user cursor associated with each user, accessing the multi-user 3D workspace room, and details of the each user adjacent to the associated active user cursor, wherein the details of the each user move together with movement of the associated active user cursor, and
wherein, in response to receiving a user input indicative of annotating the 3D object, the processor is to activate a tool, on the user interface, that causes rendering an annotation indicator, replacing the details of the user, adjacent to the active user cursor associated with the user.

18. The non-transitory computer-readable medium of claim 17, further comprising instructions, which when executed by the processor, cause the processor to:
receive a user input indicative of selection of a point on the 3D object to be annotated; and
render an annotation window associated with the selected point on the 3D object for the user to annotate the 3D object, wherein the annotation window comprises:
a multimedia annotation tab to annotate the 3D object with multimedia comprising a text, one or more images, one or more videos, and one or more files, and with one or more citations and one or more metadata tags associated with the multimedia.

19. The non-transitory computer-readable medium of claim 18, further comprising instructions which, when executed by the processor, cause the processor to:
receive from a first user, accessing the multi-user 3D workspace room, a user input indicative of selection of the annotation window associated with the point on the 3D object selected by a second user;
in response to selection of the annotation window, render a comments field, on the user interface, against each annotation in the annotation window to receive from the first user one a comment on the multimedia and entries embedded in the annotation window associated with the point on the 3D object selected by the second user, wherein the comment comprise one or more media including a textual description, an image, a video, a file, a citation, a metadata tag, or a combination thereof; and
record and render a timestamp indicative of a start time or an end time of the comments field.

20. The non-transitory computer-readable medium of claim 17, further comprising instructions which, when executed by the processor, cause the processor to:
receive a user input selecting an image corresponding to a 3D workspace template;
import, from a memory of the computing device or from an external computing device, of a 3D workspace file corresponding to the 3D workspace template; and
render the 3D workspace template, from the imported 3D workspace file, on the 3D workspace, wherein the 3D workspace template comprises one of:
a floor;
a floor with at least one wall;
a floor with at least one wall and a ceiling;
a floor with at least two partitioning walls; or
a floor with at least two partitioning walls and a ceiling.
